(19) United States
(12) Patent Application Publication
(10) Pub. No.: US 2026/0300032 A1
(43) Pub. Date: Oct. 1, 2026

(54) FEDERATING CONTROL OVER MULTIPLE HETEROGENOUS COMPUTING INFRASTRUCTURES

(71) Applicant: Nutanix, Inc., San Jose, CA (US)

(72) Inventors: Amitesh Madhur, Fremont, CA (US); Pawan Ghildiyal, Cupertino, CA (US); Uday Bhaskar, San Jose, CA (US); Harish Sekar, Bellevue, WA (US); Manoj Thirutheri, San Jose, CA (US); Shamli Sudhirchandra Singh, San Jose, CA (US)

(73) Assignee: Nutanix, Inc., San Jose, CA (US)

(21) Appl. No.: 19/438,200

(22) Filed: Dec. 31, 2025

Related U.S. Application Data
(60) Provisional application No. 63/777,669, filed on Mar. 25, 2025.

(51) Int. Cl. G06F 9/50

(52) U.S. Cl. CPC G06F 9/5077; G06F 9/5072

(57) ABSTRACT

In a system where a plurality of computing clouds host a plurality of tenant partitions, a method proceeds by configuring a first credentialing facility for first authentication and authorization to provide access to a first set of virtualization system entities on a first cloud infrastructure that hosts at least one of the tenant partitions, and configuring a second credentialing facility for second authentication and authorization so as to provide access to monitor and change either one or both of the first virtualization system entities and/or the second set of virtualization system entities even when the second cloud infrastructure is at least in some aspect different from the first cloud infrastructure. At least some aspects of the first set of virtualization system entities are presented in a user interface and at least some aspects of the second set of virtualization system entities are presented in the same user interface.

### RELATED APPLICATIONS

The present application claims the benefit of priority to U.S. Provisional Patent Application Ser. No. 63/777,669 titled, “FEDERATING CONTROL OVER MULTIPLE HETEROGENOUS COMPUTING INFRASTRUCTURES” filed on Mar. 25, 2025, which is hereby incorporated by reference in its entirety.

### TECHNICAL FIELD

This disclosure relates to computing deployments, and more particularly to techniques for federating control over multiple heterogenous computing infrastructures.

### BACKGROUND

Cloud computing has become ubiquitous as has the emergence and uptake of virtualization systems. Modern cloud computing vendors have attempted to address this by enabling customer-driven, on-demand delivery of computing resources (e.g., storage, software) that are flexibly configured for certain purposes or outcomes. Such computing resources, especially in cloud computing, can be shared in a secure manner. For example, even though multiple customers may share a particular computing system infrastructure, the deployments are nevertheless secure, at least in the sense that one customer (e.g., tenant) cannot access another customer's (e.g., tenant's) deployment.

Given the flexibility and confidence afforded by this notion of tenancy, the notion of tenancy is now being applied to individual departments and/or activities of a particular customer. This affords great flexibility to organizations and their deployments such that, for example, one department (e.g., the Accounts Payable department of Customer X) can choose a cloud infrastructure that has favorable pricing for related computing workloads, whereas a different department (e.g., the Engineering Department of Customer X) might want to choose a different cloud infrastructure that has favorable pricing with respect to large volumes of long-term data storage.

Historically, a given company relies on a single IT organization to handle IT needs for all departments. In the situation where the company operates its own infrastructure, this model might work fine. However, when multiple different infrastructures (e.g., cloud infrastructures) are used, such as was introduced in the previous scenario, this leads to operational challenges. Specifically, the IT department personnel now need to know how to manage not only the company's own infrastructure (so-called on-prem equipment), but also how to manage public cloud infrastructures, possibly even multiple cloud infrastructures (e.g., multiple public cloud) infrastructures. The situation becomes manifest as more and more departments choose to avail themselves of more and more- and often vastly different-clouds. This situation becomes even more complicated when departments deploy software applications that span multiple different clouds. Even further, this situation becomes still more complicated when one considers that a public cloud might host tenant-provided cluster configuration code and/or when one considers that a public cloud might host any of a variety of virtualization systems, etc.

To further explain, consider an application (e.g., a configuration of multiple virtual machines) that has a first workload that demands a lot of processing power (e.g., GPUs in an AI-enabled mesh) and a second workload that demands a lot of storage capacity (e.g., exabytes of long-term storage). It would be reasonable that the first workload would be hosted on a cloud infrastructure that offers favorable pricing for raw computing, whereas the second workload would be hosted on a different cloud infrastructure that offers favorable pricing for storage.

Unfortunately, this creates a problem for the IT administrators. Specifically, in absence of the innovations presented herein, the IT administrators would need to become fluent with both cloud systems. Moreover, this sets up the situation where there is duplication of effort (e.g., in duplicate, in triplicate, etc.) as may be required to make a change at a first public cloud (e.g., an application partitioning change) and then reflect aspects of that change at a second public cloud. Further, with more cloud deployments being rolled out every day, and especially in current times where there is a premium attached to security- and service-level agreements, this model does not scale. It is simply unreasonable that IT personnel be fluent with all of the constructs (e.g., virtualization constructs, storage offerings, computer code languages, application programming interfaces, etc.) that arise in the face of deployments into multiple heterogeneous cloud systems, and it's even more unreasonable that IT personnel be forced to manage a single change (e.g., a change to an application) across multiple heterogeneous cloud systems. Therefore, new technological advances for cloud interfaces and other new technological advances are needed to bring about inter-cloud federation.

The problem to be solved is therefore rooted in various technological limitations of legacy approaches. Improved technologies are needed. In particular, improved applications of technologies are needed to address the aforementioned technological limitations of legacy approaches.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and computer program products for federating control over multiple heterogenous computing infrastructures, which techniques advance the relevant technologies to address technological issues with legacy approaches. More specifically, the present disclosure describes techniques used in systems, methods, and in computer program products for lifecycle management of computing system deployments across multiple heterogenous computing infrastructures. Certain embodiments are directed to technological solutions for a federated management of computing system deployments that span across multiple heterogenous computing infrastructures.

The disclosed embodiments modify and improve beyond legacy approaches. In particular, the herein-disclosed techniques provide technical solutions that address the technical problems attendant to the inexorable roll-out of more and more cloud offerings onto more and more different infrastructures. Such technical solutions involve specific implementations (e.g., data organization, data communication paths, module-to-module interrelationships, etc.) that relate to the software arts for improving computer functionality. Various applications of the herein-disclosed improvements in computer functionality serve to reduce demand for computer memory, reduce demand for computer processing power, reduce network bandwidth usage, and reduce demand for intercomponent communication. For example, when performing computer operations that address the various technical problems underlying the inexorable roll-out of more and more cloud offerings onto more and more different infrastructures, both memory usage and CPU cycles demanded are significantly reduced as compared to the memory usage and CPU cycles that would be needed but for practice of the herein-disclosed techniques, in particular techniques for implementing a federated model for management of computing system deployments that span across multiple heterogenous computing infrastructures. Strictly as one case, the data structures as disclosed herein, and their use, serve to reduce both memory usage and CPU cycles as compared to alternative approaches. Moreover, information that is received during operation of the embodiments is transformed by the processes that store data into and retrieve data from the aforementioned data structures.

The ordered combination of steps of the embodiments serve in the context of practical applications that perform steps for a federated model for management of computing system deployments that span across multiple heterogenous computing infrastructures more efficiently. As such, techniques for a federated model for management of computing system deployments that span across multiple heterogenous computing infrastructures overcome long-standing yet heretofore unsolved technological problems associated with the inexorable roll-out of more and more cloud offerings onto more and more different infrastructures that arise in the realm of computer systems.

Many of the herein-disclosed embodiments for a federated model for management of computing system deployments that span across multiple heterogenous computing infrastructures are technological solutions pertaining to technological problems that arise in the hardware and software arts that underlie modern computing infrastructure management. Aspects of the present disclosure achieve performance and other improvements in peripheral technical fields including, but not limited to, human-machine interfaces and high-performance computing.

Some embodiments include a sequence of instructions that are stored on a non-transitory computer readable medium. Such a sequence of instructions, when stored in memory and executed by one or more processors, causes one or more processors to perform a set of acts that implement a federated model for management of computing system deployments that span across multiple heterogenous computing infrastructures.

Some embodiments include the aforementioned sequence of instructions that are stored in a memory, which memory is interfaced to one or more processors such that the one or more processors can execute the sequence of instructions to cause the one or more processors to implement acts for a federated model for management of computing system deployments that span across multiple heterogenous computing infrastructures.

In various embodiments, any combinations of any of the above can be organized to perform any variation of acts for lifecycle management of computing system deployments across multiple heterogenous computing infrastructures, and many such combinations of aspects of the above elements are contemplated.

Further details of aspects, objectives and advantages of the technological embodiments are described herein and, in the figures, and claims.

### BRIEF DESCRIPTION OF THE DRAWINGS

The drawings described below are for illustration purposes only. The drawings are not intended to limit the scope of the present disclosure. This patent or application file contains at least one drawing executed in color. Copies of this patent or patent application publication with color drawings will be provided by the U.S. Patent and Trademark Office upon request and payment of the necessary fee.

FIG. 1A and FIG. 1B1 combine to illustrate differences between a legacy system and the advances disclosed herein.

FIG. 1B2, FIG. 1B3, and FIG. 1B4 are architectural diagrams showing alternative constituencies of multiple clouds.

FIG. 1B5 is an architectural diagram showing an alternative constituency of multiple clouds in which virtual machine-based deployments are supported.

FIG. 2 is an architectural diagram showing a user interface that amalgamates information derived from multiple independently operated clouds where each cloud hosts a software-as-a-service deployment for a particular tenant, according to some embodiments.

FIG. 3A is an architectural diagram that includes a representation of a heterogeneous cloud information gathering technique where the cloud hosts a virtualization system as used in systems that facilitate lifecycle management of computing system deployments across multiple heterogenous computing infrastructures, according to some embodiments.

FIG. 3B is a protocol diagram that implements a heterogeneous cloud information gathering technique where the cloud hosts a virtualization system as used in systems that facilitate lifecycle management of computing system deployments across multiple heterogenous computing infrastructures, according to some embodiments.

FIG. 4 depicts an example model generation engine showing parameterized performance and configuration data as produced by a tenant-isolated model generation engine, according to an embodiment.

FIG. 5 depicts a high-level block diagram of a system for bringing up a computing cluster on any one of a plurality of public cloud infrastructures.

FIG. 6 depicts system components as arrangements of computing modules that are interconnected so as to implement certain of the herein-disclosed embodiments.

FIG. 7A, FIG. 7B, FIG. 7C, and FIG. 7D depict virtualization system architectures comprising collections of interconnected components suitable for implementing embodiments of the present disclosure and/or for use in the herein-described environments.

### DETAILED DESCRIPTION

Aspects of the present disclosure solve problems associated with using computer systems for the inexorable roll-out of more and more cloud offerings onto more and more different infrastructures. These problems are unique to, and may have been created by, various computer-implemented methods that address the inexorable roll-out of more and more cloud offerings onto more and more different infrastructures. Some embodiments are directed to approaches for a federated model that spans across multiple heterogenous computing infrastructures. The accompanying figures and discussions herein present example environments, systems, methods, and computer program products for lifecycle management of computing system deployments across multiple heterogenous computing infrastructures.

### Overview

The Tower of Babel of cloud computing has created a problem for IT administrators. With so many cloud computing offerings coming to the market every day, it has become unreasonable to expect that IT personnel be fluent with all of the constructs (e.g., virtualization constructs, storage offerings, computer code languages, application programming interfaces, etc.) of different cloud offerings. This Tower of Babel type problem becomes even worse in the face of applications deployments, components of which span across multiple heterogeneous cloud systems. Furthermore, this Tower of Babel type problem extends into day-to-day management of inescapable complexities of cloud computing such as license management, security key management, software upgrades, etc.

To explain, consider a use case, where a computing cloud vendor (e.g., Nutanix, Amazon web services (AWS)) provides customer-driven on-demand computing resource products (e.g., storage licenses, software licenses, etc.) to a customer (e.g., Best Buy) in a secure manner. It often happens that even though multiple user/sub-user entities (e.g., departments of Best Buy) may deploy independently-configured partitions within the same underlying computing system infrastructure such that their independently-configured deployments (e.g., independently-configured “tenants”) remain nevertheless secure—at least in the sense that one independently-configured deployment (e.g., one tenant) or any other deployment for that matter, cannot access a different tenant's operational data.

Flexibility and confidence are afforded by implementation of use models that are based on the notion of independently configured partitions (e.g., the notion of tenants or tenancy). Such use models are applicable to individual departments (e.g., departments of Best Buy)—or even further, lower levels of partitioning. This notion of hierarchical tenant partitions is so sufficiently flexible that these hierarchical tenant partitions can facilitate division and subdivision of activities of a particular customer (e.g., Best Buy) into as finely a grained partitioning as may be needed. However, these finely grained tenant-specific boundaries that define tenant-specific partitioning lead to another problem to be solved by the invention disclosed herein. Having a plurality or multitude of independently-configured tenant-specific boundaries (e.g., tenant-specific partitions), each of which tenant-specific boundaries are secured via authentication and authorization, implies that there would need to be a plurality (or in some cases a multitude) of tenant-specific credentials- and in some cases, having a plurality or multitude of independently-configured tenant partitions. This in turn implies an unfortunate fact that there would need to be a plurality or multitude of tenant-specific administrators for each of the independently configured tenant partitions.

This sets up a problem to be solved, at least in the sense that there are two types of secure data access routes that needs to be considered: (1) operational data that is secured within the partition (e.g., data that is confidential to the customer or department), and (2) infrastructure data that is secured only as far as the boundary (but not inside) of a particular partition. Dealing with the former type of data—referring to operational data that is secured within the partition—is typically dealt with by a DevOps person or agent who is purposely credentialed to be able to (securely) oversee any sorts of operations within the partition, whereas the latter type of data is secured by credentials that provide access (e.g., role-based access control) only as far as the infrastructure boundary of a given partition. This latter type of data is the sort of data that is infrastructure-specific (that is, not confidential to any tenant). Access to this latter type of data offers the possibility that a single IT administrator can manage—at the infrastructure level—a plurality or multitude of tenant partitions without ever needing to have access to operational data (e.g., confidential information) that resides securely within the tenant partition.

Exploitation of the foregoing dichotomy between (1) access credentialing to access a tenant's confidential data, and (2) access credentialling to access infrastructure-specific data to the boundary of a given partition (but not to data inside of the given partition) sets up the situation whereby a third party (e.g., a third party who is not credentialed to access tenant-specific operational data) can make infrastructure-level decisions and infrastructure-level changes without needing to access any tenant-specific confidential information. To further elucidate on this problem and its solutions, and strictly as one example, when a customer purchases an infrastructure license from a computing cloud vendor (e.g., AWS, Nutanix) it often happens that multiple of the customer's subsidiaries (e.g., Best Buy HR, Best Buy engineering, Best Buy sales, etc.) also intend to operate under the same infrastructure license. However, in doing so, several issues can arise for IT administrators if the cloud provider cannot recognize the commonality (e.g., same top-level customer name, such as Best Buy) between tenants throughout all levels (possibly hierarchical) of the customer's tenancy. Specifically, unless IT administrators are granted visibility up to the boundaries of the partitions that correspond to, for example, departmental or functional/activity access, demands by one department or functional activity may unintentionally use another department's functional activities' allocated resources (or exceed usage limits), which in turn may impact the utility of the cloud deployment as a whole. Still more specifically, it becomes challenging for IT teams to accurately attribute costs, optimize resource allocation, and ensure that departments are only using the service or services they are in fact authorized to use.

The techniques disclosed herein provide secure and efficient methods to organize (e.g., into a hierarchical organization) tenants within a given infrastructure so as to ensure intra-partition security, while nevertheless providing visibility to resource demands that are raised by the various tenant-specific partitions. This is achieved by credentialing access to infrastructure up to the tenant-specific partitions, and then federating control over the underlying computing infrastructures. For ease of ongoing management, the (continually changing) logical topology characteristics and/or the (continually changing) logical infrastructure characteristics of each tenant-specific partition are synchronized between the first and second cloud infrastructures.

In some cases, federating control over the underlying computing infrastructures involves federating control over multiple heterogenous computing infrastructures. The disclosure hereunder provides solutions to the complexities and challenges arising from the foregoing problems.

### Federation

Federating control over multiple resources that make up a computing infrastructure—possibly involving multiple heterogenous computing infrastructures—reduces the IT burden placed on IT administrators. Federated control extends to support for geographically dispersed product development and results in overall operational efficiency. Furthermore, federating control over multiple heterogenous computing infrastructures improves infrastructure management, leads to more intelligent and adaptive cloud computing services, leads to enhanced reliability, and enhances overall return on investment from all participants within the given cloud computing ecosystem.

### Definitions and Use of Figures

Some of the terms used in this description are defined below for easy reference. The presented terms and their respective definitions are not rigidly restricted to these definitions-a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiment even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

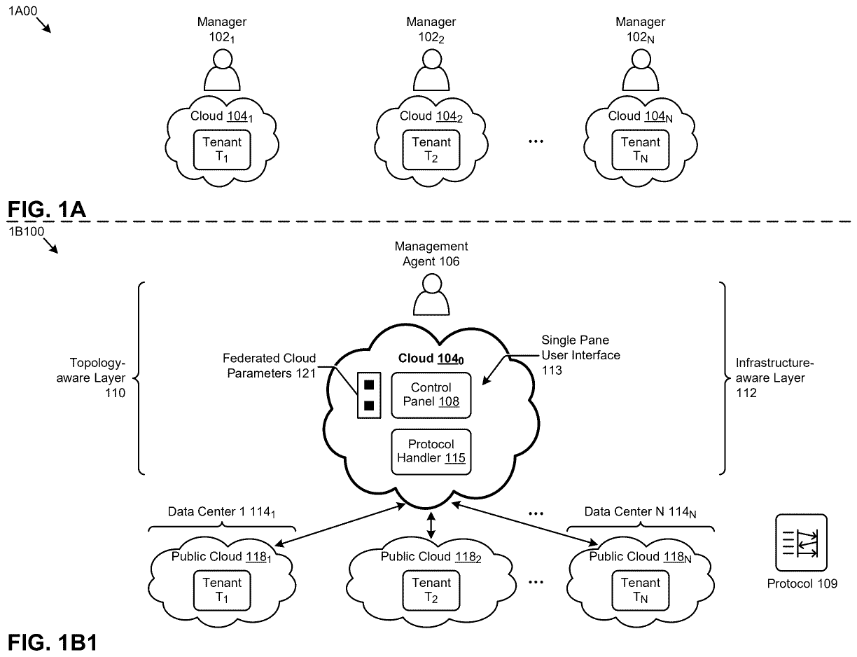

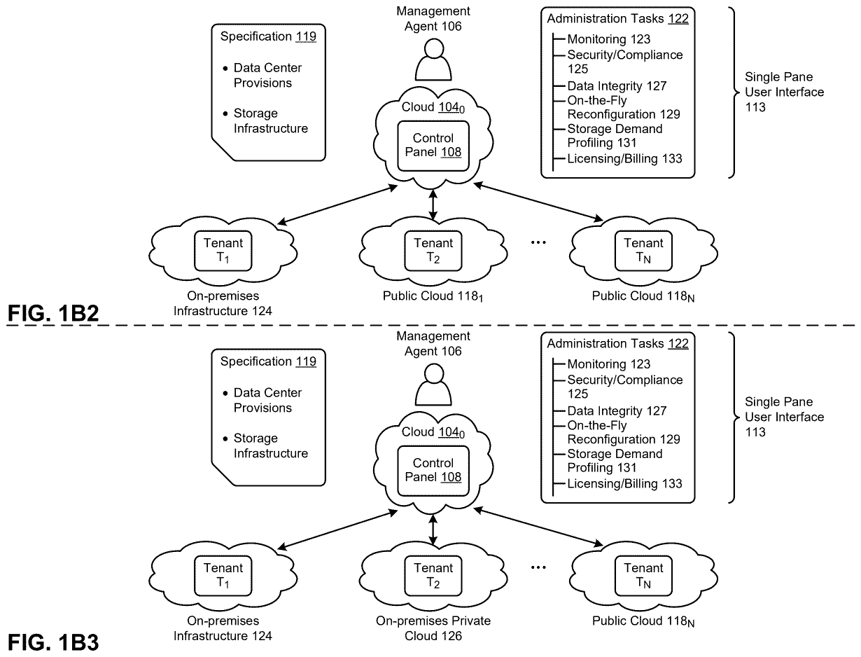

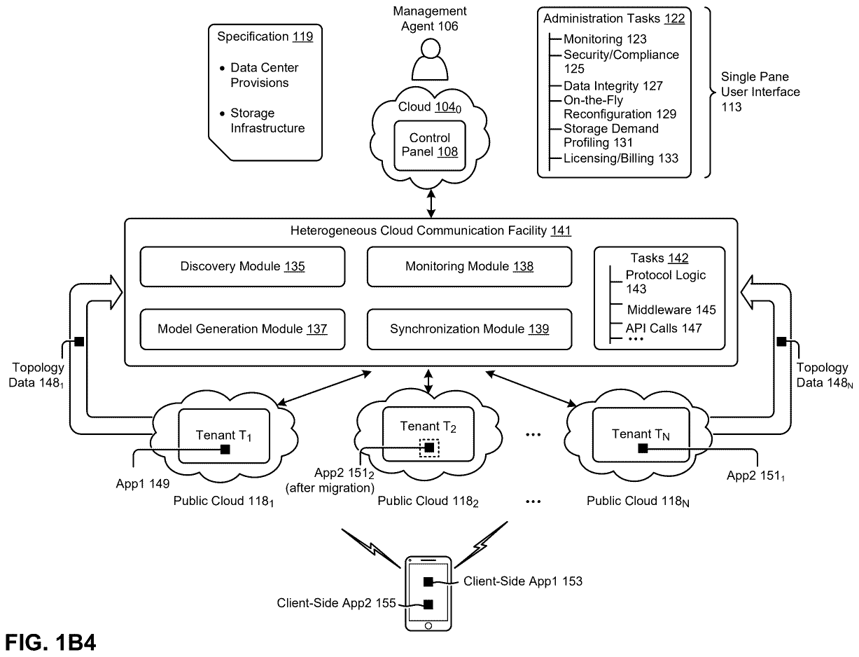

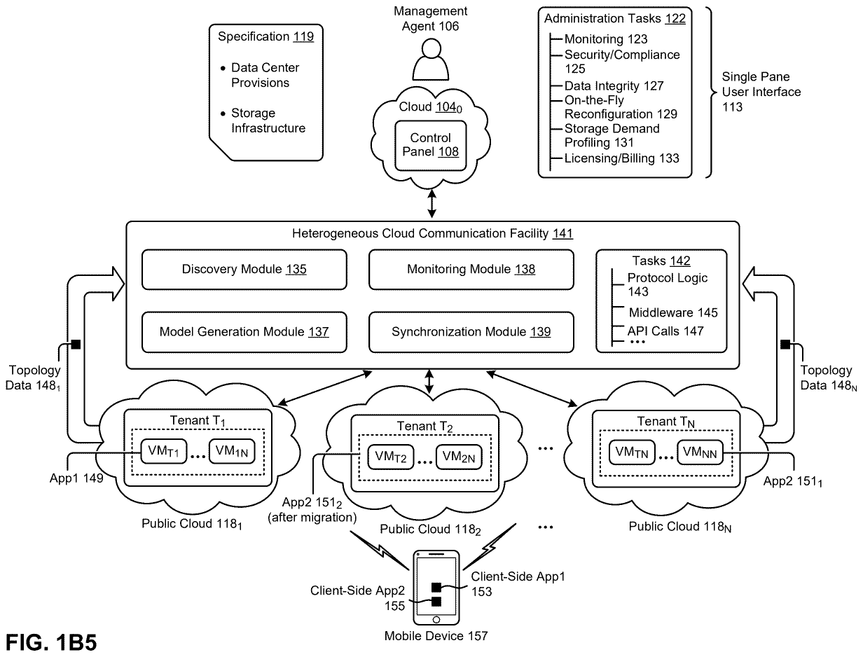

FIG. 1A and FIG. 1B1 combine to illustrate differences between a legacy system and the advances disclosed herein. As an option, one or more variations of 1A and FIG. 1B1 or any aspect thereof may be implemented in the context of the architecture and functionality of the embodiments described herein and/or in any environment.

As shown, legacy system 1A00 depicts multiple managers (e.g., manager 102₁, manager 102₂, . . . , manager 102_{N},), where each manager oversees a corresponding cloud as used by a corresponding tenant. In this system, manager 102₁ is assigned to tenant T₁, which operates within cloud 1041. Similarly, manager 102₂ is assigned to tenant T₂, which operates within cloud 1042, and similarly, manager 102_{N} oversees tenant T_{N} within cloud 104N. This one-to-one mapping between managers, tenants, and clouds creates a fragmented, isolated architecture, where each manager is restricted to their corresponding tenant and cloud environment. This in turn leads to various inefficiencies (e.g., inefficiencies related to resource sharing, inefficiencies related to security perimeter establishment, inefficiencies related to security perimeter enforcement, inefficiencies related to scaling, etc.).

As an example of how such inefficiencies emerge, consider a cloud-based software-as-a-service (SaaS) vendor. Further consider how such a SaaS title (e.g., Google Maps) might indeed be provided to different customers (e.g., Lyft, Uber, Map-R-Us, etc.). In such a SaaS implementation (and other implementations as well), each tenant (e.g., T₁=Uber, T₂=Lyft, T_{N}=Map-R-Us) is managed by a separate agent or manager (e.g., Uber's IT manager 102₁, and separately, Lyft's IT manager 102₂, and separately, Maps-R-Us' IT manager 102_{N}) where each of the separate agents or managers each oversee their particular assigned cloud environment (e.g., cloud 1041, cloud 1042, cloud 104N). This is highly undesirable, and entirely remediable through use of the herein-disclosed techniques.

To explain, it is conceivable that a unified system could be managed by a single management agent, yet without leaking propriety information of Uber's instance to Lyft, and without leaking propriety information of Lyft's instance to Uber, etc. To explain still further, it is clear that naïve legacy implementations such as depicted in FIG. 1A undesirably demand a separate agent or manager for each instance (as shown). What is worse is that in this legacy configuration, each tenant (meaning Uber and Lyft) must each employ not only their own IT expertise but also their own software-as-a-service application managers. Furthermore, when there is no unified resource management, the cloud-computing vendor must maintain multiple separate infrastructures, which unfortunately increases operational complexity and costs. What is needed is a way to federate visibility and control over multiple heterogenous computing infrastructures such that a single administrator can control aspects of all of the multiple heterogenous computing infrastructures. To still further explain, consider that (1) Uber might choose to host their “Driver Application” on a computing cloud facility that runs on on-prem servers (e.g., so Uber can maintain utter control over the resources), or that runs on first cloud infrastructure of a first cloud vendor, and (2) consider that Uber might want to also avail of a “Maps Application” that is configured to run on second cloud infrastructure of a second cloud vendor (e.g., because the second cloud vendor offers needed computing or billing features). Now, further consider that there is a relationship between certain parameters of the “Driver Application” and certain parameters of the “Maps Application”. For example, as more new drivers that use the “Driver Application” are identified, it follows that those new drivers will need correspondingly new access ports into the “Maps Application”. Absent the advances disclosed here, configuring those two applications to accommodate the new drivers would require the burden of two different administrative initiatives: a first administrative initiative to add new driver resources to the “Driver Application” to accommodate the new drivers, and a second administrative initiative to add new driver resources to the “Maps Application” to accommodate the same new drivers. Given the technical advances disclosed herein, this burden of having to carry out frequently redundant administrative actions can be eliminated. More particularly, implementation of the technical advances pertaining to the herein-disclosed user interface functions, as well as implementation of further technical advances disclosed herein result in collapsing multiple administrative initiatives into only a single administrative action needed to add resources—even though the two different applications are running on different infrastructure.

The aforementioned technique facilitates access to resources of both applications in spite of the different applications being hosted on different infrastructures. In fact, it sometime happens that the different infrastructures are similar only in that they are both computing clouds, but otherwise might bear few similarities. The following Table 1 depicts a sampling of how two different infrastructures might be realized.

TABLE 1
Examples of differences between infrastructures

| First Infrastructure | Second Infrastructure | Example Differences |
|---|---|---|
| First public cloud | Second public cloud | Vendor (e.g., Amazon AWS, Microsoft |
| | | Azure, IBM, Nutanix, etc.) |
| First virtualization system | Second virtualization system | Code base (e.g., Kubernetes, Docker, |
| | | VMWare vSphere, Microsoft Hyper-V, |
| | | Redhat KVM, Amazon EC2, Google GCP, |
| | | etc.) |
| Public cloud | On-premises cloud | Ownership, hosting location, etc. |
| First public cloud | Second public cloud | First datacenter in a first city, second |
| | | datacenter in a second city |
| First public cloud | Second public cloud | First datacenter in a first floor of a building, |
| | | second datacenter in a different floor of the |
| | | same building |
| First public cloud hosting a | Second public cloud hosting | Different tenants have different tenant- |
| first tenant | a second tenant | specific partitions for different tenant- |
| | | specific applications or purposes |
| First public cloud hosting a | Second public cloud hosting | Different tenants have different tenant- |
| first tenant | a second tenant | specific resource allocations for different |
| | | tenant-specific applications or purposes |
| First public cloud hosting a | First public cloud hosting a | Tenants correspond to any one or more of, |
| first tenant | second tenant | different departments, different |
| | | organizational functions, or different |
| | | organizational activities. |

In the latter case where tenants correspond to different departments, different organizational functions, or different organizational activities, there will be at least some differences between the virtualized entities of the different tenants. Strictly as one example, a credentialing facility of a first tenant will be different from a credentialing facility for a second tenant. As another example, there will be differences between the set of virtualization system entities of the first tenant as compared to the virtualization system entities of the second tenant. This can be true even if the set of virtualization system entities of the first tenant and also the set of virtualization system entities of the second tenant are all hosted on the same computing node.

### Hierarchically-Organized Tenant Partitions

In some cases, there is an explicit or implicit hierarchy between tenants and their respective partitions. For example, a human resource department may have an associated higher-level tenant partition, under which there might be two tenant partitions corresponding to, say one sub-partition pertaining to computing tasks that perform employee onboarding, and a further sub-partition pertaining to computing tasks that perform employee termination. As such, an exemplary deployment regime supports hierarchically-organized tenant partitions that are situated on the same cloud infrastructure but are nevertheless deemed to be separately manageable partitions, at least to the extent that they appear as separately manageable partitions in a user interface.

Implementation of some or all of the herein disclosed techniques address the deficiencies of the hereinabove mentioned naïve approaches, including but not limited to including deficiencies pertaining to aspects of tenant isolation, deficiencies pertaining to inefficiencies in resource allocations, and deficiencies pertaining to aspects of security enforcement. Various implementations of such techniques are shown and described as pertain to the figures that follow.

FIG. 1B1 illustrates an advancement over the legacy approach depicted in FIG. 1A, thus overcoming some or all of the foregoing limitations (e.g., tenant management, resource allocation, security enforcement, etc.). As shown, advancement 1B100 operates in an environment that contains heterogeneous cloud infrastructures including multiple data centers (e.g., data center 1 114₁, . . . , data center N 114_{N}), where each data center hosts computing infrastructure of a public cloud (e.g., a first public cloud 118₁, a second public cloud 118₂, . . . , an Nth public cloud 118_{N}). As is understood by those of skill in the art, each public cloud infrastructure might be hosted on respective heterogeneous infrastructures (e.g., Amazon Web Services hosted on a first infrastructure configuration, Google Cloud hosted on a second infrastructure configuration, and Microsoft Azure hosted on a third or Nth infrastructure configuration, etc.). As such, each separate infrastructure might serve different respective tenants (e.g., tenant T₁, tenant T₂, tenant T₃). In some embodiments, management agent 106 is positioned within (or otherwise associated with) cloud 104₀ and is configured to obtain information from the heterogeneous cloud infrastructures so as to perform unified oversight and management functions across those infrastructures.

It often happens that one cloud infrastructure might be particularly well suited for high-performance CPU computing, whereas a second cloud infrastructure might be particularly well suited for data storage, and whereas a third cloud infrastructure might be particularly well suited for high performance in other computing dimensions. Given a situation where a first tenant's workload is dominated by high-performance CPU computing demands, that situation would suggest that a first tenant would select a cloud infrastructure that is particularly well suited for high-performance computing. Similarly, given a case where a second tenant's workload is dominated by storage I/O (input/output or IO) demands, that would suggest that a first tenant would select a cloud infrastructure that is particularly well suited for handling storage I/O. One can observe that even though different workloads might be dominated by, for example CPU usage demands versus storage I/O demands, those workloads tend to use, at least to some extent, some amount of nearly all types of computing resources (e.g., CPU, storage, networking bandwidth, GPUs, etc.). This sets up the situation where it is felicitous to federate the various types of computing resources in a common view.

More particularly, synchronization of data between heterogeneous cloud infrastructures supports federated visibility and control over multiple heterogenous computing infrastructures such that a single administrator can control aspects of all of the multiple heterogenous computing infrastructures. When data between heterogeneous cloud infrastructures is synchronized (and normalized), a single visualization (e.g., a dashboard, a graphical user interface, etc.) can be deployed, wherein this single visualization serves both functions of federated visibility and federated control over multiple heterogenous computing infrastructures.

### Unified Dashboard Over Multiple Heterogeneous Cloud Infrastructure

As shown, a centralized, unified dashboard that enables federated management of tenants, resources, and policies over the heterogeneous infrastructures is provided by single pane user interface 113. Such a single pane user interface is populated in response to interactions between cloud 104₀ and each data center. As illustrated, interrogation occurs between control panel 108 and heterogenous infrastructures, via protocol 109, in order to amalgamate data across the cloud environment into a file (e.g., a cluster summary file (not shown)) according to this embodiment. This is because the amalgamated data is then stored (e.g., as a non-volatile object) and structured in a manner such that the control panel can retrieve, modify, and write back into the same or similar stored structure.

In one example partitioning, an infrastructure-aware layer 112 and/or a topology-aware layer 110 are situated so as to process cloud-specific data (e.g., cloud-specific structures and/or SaaS-specific profiles), and then amalgamate synchronized information (e.g., federated cloud parameters 121) for presentation in the control panel 108 of cloud 104₀. As such, these layers serve to federate both visibility and control over multiple heterogenous computing infrastructures, in turn enabling various improvements in the computing (e.g., tenant management and organization, resource allocation, etc.) on the heterogenous infrastructures. Federation of characteristics of specific tenants (e.g., mapping of specific tenants onto an infrastructure) is accomplished via the shown infrastructure-aware layer 112 and, in some cases, the topology-aware layer 110. In situations like this, cloud 104₀ hosts a protocol handler 115, which protocol handler is configured to be able to interrogate other clouds (e.g., public cloud 118₁, public cloud 118₂, . . . , public cloud 118_{N}), and/or any number of tenants (e.g., tenant T₁, tenant T₂, . . . , tenant T_{N}), so as to obtain entity information from the cloud or tenant, and then to synchronize said information for display into and/or for control by the shown control panel 108.

Such synchronization allows the infrastructure-aware layer to provide or facilitate provision of various services (e.g., applying licenses, renewing terms of service, migrating from one place to another, etc.). More specifically, such synchronization allows the management agent 106 to provide or facilitate provision of various services even in the face of heterogeneous cloud infrastructures. Moreover, such synchronization and the analysis that is performed over the synchronized information allows the management agent to provide or facilitate provision of services even in the face of changing conditions that may occur in or by any operational elements that comprise the several heterogeneous cloud infrastructures.

To illustrate, consider the following example: A cloud-computing vendor (e.g., Amazon) licenses a flight of cloud services (e.g., Amazon EC2, AWS Lambda, AWS Outposts) to a customer (e.g., Best Buy) which licenses are configured to enable Best Buy's various departments (e.g., Best Buy Sales, Best Buy Engineering, Best Buy HR, etc.) to access and use the licensed product. A department representative or proxy logs into the cloud provider's platform using their credentials as pertains to a respective department. Once infrastructure-aware layer 112 and topology-aware layer 110 are operational, the cloud-computing vendor becomes tenant aware and can map and oversee tenancy at a hierarchical level above the department level. This eliminates the need for each department to employ respective department representatives on a per-department basis.

The foregoing discussion of FIG. 1B1 pertains to merely some possible embodiments and/or ways to implement infrastructure-aware layer 112 and topology-aware layer 110 such that a single manager agent can oversee multi-tenancy from a hierarchical level above the lower-level (e.g., department level) cloud infrastructures. Many variations are possible and can be implemented in any environment.

FIG. 1B2 and FIG. 1B3 are architectural diagrams showing alternative constituencies of multiple clouds. As an option, one or more variations of FIG. 1B2 and FIG. 1B3 or any aspect thereof may be implemented in the context of the architecture and functionality of the embodiments described herein and/or in any environment.

FIG. 1B2 is presented to illustrate an alternative embodiment in which the disclosed advances can be applied. In this embodiment, an environment is shown to include heterogeneous infrastructures. As shown, the environment consists of an on-premises infrastructure 124 (e.g., laptops, servers, public clouds), public cloud 118₁ (e.g., Nutanix cloud platform), and multiple public clouds ranging up to public cloud 118_{N} (e.g., AWS).

Within the environment, the heterogeneous infrastructures are shown to contain corresponding tenants (e.g., tenant T₁, tenant T₂, . . . , tenant T_{N}). Despite the variation in the environment relative to FIG. 1B1, interrogation between control panel 108 and each of the heterogeneous infrastructures may still be performed. Information (e.g., metadata) obtained through the interrogation is amalgamated across the environment into a file (e.g., cluster summary file (not shown)). Based on the amalgamated information, an infrastructure-aware layer and topology-aware layer are created and then subsequently applied to cloud 104₀. As a result, information describing a structure and a topology of the on-premises infrastructure 124 (e.g., laptops, servers, private clouds), public cloud 118₁ (e.g., Nutanix cloud platform), and multiple public clouds ranging up to public cloud 118_{N} (e.g., AWS) is made available to the management agent.

Once the infrastructure-aware layer and the topology-aware layer have been applied, administration tasks 122 (e.g., monitoring 123, security/compliance 125, data integrity 127, on-the-fly reconfiguration 129, storage demands profiling 131, licensing/billing 133) can now be provided to the tenants by the management agent. Furthermore, specification 119 is also made visible to the management agent, thereby enabling the management agent to incorporate details of the specification into execution of the administration tasks across the different heterogeneous infrastructures.

FIG. 1B3 is being presented to illustrate an alternative embodiment in which the advancement can be applied. The environment includes heterogeneous infrastructures that consist of on-premises infrastructure 124 (e.g., laptops, servers, public clouds), on-premises private cloud 126 (e.g., private stack, Nutanix cloud platform), . . . , public cloud 118_{N} (e.g., AWS, Microsoft Azure). Within this environment, heterogeneous infrastructures contain different tenants (e.g., tenant T₁, tenant T₂, . . . , tenant T_{N}). Despite the variation in the environment compared to FIG. 1B1 and FIG. 1B2, interrogation between control panel 108 and each heterogeneous infrastructure occurs to amalgamate data across the cloud environments into a file (e.g., cluster summary file (not shown)). This is because the amalgamated data is then stored and structured (e.g., an object structure) in a way that the control panel can retrieve. An infrastructure-aware layer and topology-aware layer are created by the amalgamated data, then applied to cloud 104₀. Thus, enabling information about the structure and topology of on-premises infrastructure 124 (e.g., laptops, servers, public clouds), on-premises private cloud 126 (e.g., private stack, Nutanix cloud platform), . . . , public cloud 118_{N} (e.g., AWS, Microsoft Azure) can be made available to the management agent.

Tenant-specific results from administration tasks 122 (e.g., monitoring 123, security/compliance 125, data integrity 127, on-the-fly reconfiguration 129, storage demands profiling 131, licensing/billing 133, etc.) can now be provided to the tenants by the management agent. Specification 119 can now also be seen by the management agent, enabling the agent to incorporate these details into the administration tasks for the different infrastructures.

The foregoing discussion of FIG. 1B2 and FIG. 1B3 pertains to merely some possible embodiments and/or architectures. Many variations are possible and can be implemented in any environment.

FIG. 1B4 is an architectural diagram showing an alternative constituency of multiple clouds. As an option, one or more variations of FIG. 1B4 or any aspect thereof may be implemented in the context of the architecture and functionality of the embodiments described herein and/or in any environment.

FIG. 1B4 is presented to illustrate an alternative embodiment in which tenant-isolated topology discovery, modeling, and synchronization are applied within a heterogeneous multi-cloud environment.

In this embodiment, heterogeneous cloud communication facility 141 is introduced into the environment, which includes a set of multi-cloud processing components such as discovery module 135, model generation module 137, monitoring module 138, and synchronization module 139. These modules collectively enable management agent 106 associated with cloud 104₀ to receive normalized, tenant-safe operational data from multiple cloud infrastructures. This allows a control panel to make meaningful infrastructure-level decisions even though each tenant (e.g., tenants T₁, T₂, . . . , T_{N}) maintains a strict, security-wise, impenetrable boundary.

The heterogeneous cloud communication facility does not access tenant data or internal tenant logic; instead, it provides only anonymized and infrastructure-specific indicators needed for cross-tenant evaluation and remediation. Topology data (e.g., topology data 148₁, . . . , topology data 148_{N}) shown being returned from each public cloud (e.g., public cloud 118₁, public cloud 118₂, . . . , public cloud 118_{N}) is used to maintain this privacy-preserving separation.

To illustrate, consider a ride-hailing service (e.g., Uber) that employs two primary functional components: a first component that manages user-interface interactions and driver interactions (e.g., via a client-side app1 153, client-side app2 155, which are hosted on mobile device 157) in a client/server arrangement, and a second component responsible for maps and navigation services (e.g., app1 149 and app2 151₁).

The heterogeneous cloud communication facility observes infrastructure-level behaviors associated with these components—such as compute load, traffic volume, inter-application latency, storage throughput, and network congestion—via monitoring module 138, while still maintaining full tenant isolation. Discovery module 135 identifies structural and operational characteristics, model generation module 137 produces an abstract topology model for cross-cloud comparison, and synchronization module 139 maintains consistency of topology and performance indicators across the heterogeneous infrastructures. A task execution subsystem (e.g., tasks 142) uses its protocol logic 143, middleware 145, and API calls 147 to standardize and execute actions across dissimilar cloud environments. This unified operational framework enables the management agent, via the control panel, to make informed infrastructure-wide decisions based on real-time topology and performance conditions.

To illustrate by example, consider the case when a ride-hailing service launches in a new city. While the initial deployment may be sufficient to support the limited amount of traffic from a small number of drivers and riders, as usage in the new city grows, the heterogeneous cloud communication facility might experience (and detect) increasing load. Based at least in part on its synchronized topology mode generated by the model generation module and maintained by the synchronization module, the heterogeneous cloud communication facility might observe performance degradation in the form of longer and longer latencies in end-to-end network communications.

In response, the facility may propose remediation actions to the management agent, such as increasing the number of server-side instances (e.g., increasing the number of virtual machine instances hosted by migrated app2 151₂) supporting the ride-hailing application or, alternatively, relocating the server-side deployment to a data center that is geographically closer to the new city using the action pathways provided by tasks 142 (e.g., through use of protocols and logic 143, through use of middleware 145, or through use of API-calls 147).

Using the techniques disclosed herein, these recommendations can be generated without breaching tenant boundaries. This is because the foregoing recommendations and/or remediation actions are determined based solely on privacy-preserved, normalized topology information obtained by and maintained by the shown heterogeneous cloud communication facilities. More particularly, without breaching tenant boundaries, and while still observing privacy-preserving policies, various infrastructure-specific topology (and other non-confidential information) can be synchronized between the heterogeneous cloud infrastructures. This can be accomplished by the herein-disclosed heterogeneous cloud communication facility 141 (as shown in the center portion of FIG. 1B4).

While FIG. 1B4 illustrates how the herein-disclosed techniques can be applied to application-level deployments distributed across heterogeneous cloud infrastructures, similar principles can be applied in environments where the primary deployable unit comprises virtual machines rather than application components. Accordingly, FIG. 1B5 (described next) presents an alternative embodiment in which topology discovery, model generation, monitoring, and synchronization are performed with respect to virtual-machine instances operating across multiple heterogeneous clouds. In such embodiments, the heterogeneous cloud communication facility operates over VM-level constructs—such as VM state, VM placement, VM migration, and VM resource consumption—while maintaining the same tenant-isolation guarantees and privacy-preserving behaviors as described above. Thus, the techniques disclosed with reference to FIG. 1B4 can be extended to support machine-level orchestration across federated cloud infrastructures.

### Federated Authentication

In some embodiments, an on-premises virtualization system interacts through a firewall to access a cloud-based identity and authentication manager that is configured to validate credentials, exchange metadata, and negotiate secure session parameters. The identity provider and authentication manager may further communicate with one or more key-management services to perform secure handshake operations. Information exchanged, generated, or gathered during these interactions can be stored in a database for subsequent use in multi-cloud management operations.

The information stored in the database may be represented in any suitable form. In certain embodiments, the information is represented using a JSON-based data structure that captures cloud-specific parameters gathered from heterogeneous deployments. Such a representation can include fields that support ongoing management of multiple clouds that are organized into a multi-cloud management scenario. By way of example and without limitation, the representation may include a tenant identifier, a tenant account number, tenant subscription information, and any number of tenant-specific properties. These structured values may be consumed by downstream components—such as a model generation engine—to construct normalized, tenant-isolated topology and performance models. These normalized models enable the management agent to evaluate operational conditions and recommend remediation actions while maintaining complete tenant isolation as described in connection with the heterogeneous cloud communication facility. Strictly as an example, the herein-disclosed federated cloud parameters correspond to normalized models that contain at least one normalized characteristic that is/are shared between two or more cloud infrastructures or between two or more cloud infrastructure topologies. To further explain, federated cloud parameters describe characteristics up to boundaries of respective tenant partitions—yet without violating complete tenant isolation during the use of (e.g., reading or changing) said federated cloud parameters. That is, in spite of the fact that normalized characteristics can be shared between two or more cloud infrastructures or between two or more cloud topologies, the techniques disclosed herein observe tenant isolation constraints imposed by tenant isolation regimes.

The foregoing discussion of FIG. 1B4 pertains to merely some possible embodiments and/or architectures. Many variations are possible and can be implemented in any environment.

FIG. 1B5 is an architectural diagram showing an alternative constituency of multiple clouds in which virtual machine-based deployments are supported. As an option, one or more variations of FIG. 1B5, or any aspect thereof, may be implemented in the context of the architecture and functionality of the embodiments described herein and/or in any environment. This embodiment is presented to illustrate how the herein-disclosed techniques for topology discovery, model generation, monitoring, synchronization, and cross-cloud orchestration can be applied to virtualization-system constructs (e.g., virtual machines and associated infrastructure) operating across heterogeneous cloud infrastructures.

In the embodiment of FIG. 1B5, a heterogeneous cloud communication facility is used to manage, analyze, and synchronize information across multiple heterogeneous cloud infrastructures so as to result in an inter-cloud synchronized virtualized application deployment even when the clouds are heterogeneous. More particularly, the synchronized virtualized application deployment is able to synchronize federated cloud parameters between any two or more of, a first public cloud, a second public cloud, or on-premises infrastructure.

As shown, the heterogeneous cloud communication facility 141 includes several coordinated processing components, including a discovery module, a model generation module, a monitoring module, a synchronization module, and a task execution subsystem (the task execution subsystem including a protocol, middleware, and API-calls). Together, these components collectively enable the system to observe and interpret operational, performance, and topological characteristics of virtual-machine deployments distributed across multiple clouds.

The topology data (e.g., topology data 148₁, . . . , topology data 148_{N}) gathered from the heterogeneous cloud infrastructures is used to represent the logical and physical characteristics of tenant-specific virtualization environments. The term “topology” as used here includes, but is not limited to, virtual machine placement, virtual-machine-to-host relationships, network adjacency structures, inter-virtual machine communication paths, storage-access characteristics, and any other infrastructure-level construct that describes how the virtual machines are situated within or across the public clouds. Importantly, such topology data is tenant-scoped, and is generated in a manner that maintains tenant isolation and privacy preservation. That is, the heterogeneous cloud communication facility does not access tenant-owned data or internal tenant logic; instead, it obtains only normalized, infrastructure-safe indicators of virtual machine behavior and placement.

As used herein, the terms tenant-scoped data and/or tenant-scoped synchronization refers to the notion that tenant isolation (e.g., tenant scoping) guarantees that tenant-confidential data does not need to be accessed in order to achieve the technological advances as disclosed herein. Any manner of computing and/or data manipulation can take place within tenant boundaries, and as such, computing and/or data manipulation that takes place within tenant boundaries is not needed to be accessed in order to avail of the technological advances disclosed herein. In some cases, the manner and types of computing and/or data manipulation that takes place within a tenant boundary is extensive, possibly including myriad virtualized entities (e.g., virtual machines, virtual storage, etc.), which in turn may be configured as one or more applications.

As illustrated, each tenant hosts an application that is composed of multiple virtual machines (e.g., virtual machine VM_{T1}, . . . , virtual machine VM_{IN}, virtual machine VM_{T2}, . . . , virtual machine VM_{2N}, ranging up to virtual machine VM_{TN}, . . . , virtual machine VM_{NN}), each executing under a respective virtualization system regime provided by the underlying public cloud. These virtual machines support various application components, backend services, or microservices associated with the tenant's workload. Techniques for using virtualization systems and for orchestrating virtual machines in a public-cloud environment are described, for example, in U.S. Pat. No. 10,484,301 titled “DYNAMIC RESOURCE DISTRIBUTION USING PERIODICITY AWARE PREDICTIVE MODELING” issued on Nov. 19, 2019, which is hereby incorporated by reference in its entirety.

This virtual machine-centric configuration sets the stage for scenarios in which virtual machine (VM) level management and optimization are required. Because the heterogeneous cloud communication facility is able to continuously discover VM placement, generate cross-cloud topology models, monitor health and performance characteristics, and maintain synchronized states across the heterogeneous clouds, the system is able to support machine-level remediation, resource balancing, and cross-cloud orchestration.

To restate this in the context of the earlier ride hailing service example, consider the mapping component of the ride-hailing workload. Initially, this mapping service might be deployed as a set of virtual machines hosted on a virtualization system in public cloud 118_{N}. As usage grows, or as conditions change (e.g., increased latency, resource saturation, changes in network traffic), the heterogeneous cloud communication facility may determine—based solely on privacy-preserved topology information—that a cross-cloud migration would improve performance or resource utilization. Accordingly, the system may propose and/or facilitate the migration of the mapping-service virtual machines from public cloud 118_{N} to public cloud 118₂. This state is shown by the placement of application app2 151₂ within the boundary of tenant T₂ on public cloud 118₂ after migration. After migration, the heterogeneous cloud communication facility continues to monitor, synchronize, and update the topology models so that the management agent can maintain a consistent federated view of the virtual-machine deployments across all clouds.

Through this arrangement, FIG. 1B5 demonstrates that the techniques described above for application-level deployments (e.g., with reference to FIG. 1B4) can be applied equally—even seamlessly—to virtual machine-level deployments. This allows operators to manage VM-based workloads across heterogeneous public clouds using a unified, privacy-preserving management framework.

As is known in the art, each independent public cloud—and moreover each virtualization-system entity hosted therein—may have a corresponding credentialing technique whereby one or more administrators are credentialed for authentication and authorization to provide access to a set of such virtualization system entities on a particular cloud infrastructure that hosts at least one tenant partition. Also as is known in the art, each independent cloud may have its own cloud-specific credentialing facility through which a putative set of cloud-specific administrators are credentialed for cloud-specific authentication and authorization so as to enable monitoring and modification of that cloud-specific set of virtualization system entities. Furthermore, the aforementioned independent clouds may each avail of a respective user interface through which at least some aspects of said virtualization system entities on either cloud might have similar semantics. For example, although each independent cloud may have its own parameter representations in respective user interfaces, the meaning of “storage” might be semantically the same even though the name that one independent cloud vendor might use to refer to “storage” might be “elastic storage”, whereas a second independent cloud vendor might refer to “storage” as “blob storage” or “block storage”. Of course, the foregoing is merely one example of a wide range of aspects that are quantified (and/or qualified) in the various cloud-specific user interfaces. Moreover, and as is known in the art, even though there might be differences in names or terms used by different cloud vendors, there is often a common underlying semantic that can be normalized. For example, a resource demand for 1 terabyte of storage could be specified by a first vendor as 1*10E9 (giga) blocks of size 1024 bytes, whereas the same 1 terabyte of storage could be specified by a second vendor as 2*10E9 (giga) blocks of size 512 bytes. Such differences in representation are easily normalized when the underlying semantic is the same or nearly the same. The following Table 2 offers examples of differences between aspects of infrastructures.

TABLE 2
Examples of differences between aspects of infrastructures

| | Term used by first | Term used by second | |
|---|---|---|---|
| Aspect | Infrastructure | Infrastructure | Common Semantic |
| Block storage resource | “Hot storage” or | “Random access blocks” | Resource to storage bits for random |
| | “tier1 storage” | | access retrieval |
| Cold storage resource | “Glacier” | “Blob storage” | Resource to storage bits for |
| | | | “probably never” or “non-periodic” |
| | | | access |
| Computing power | “Virtual CPUs” | “Virtual cores” | Instruction processors |
| Networking | Ports | Interfaces | Bandwidth |
| Virtual Machine | VM | Container | Executable unit |
| Ingress | Incoming data | Received data | Amount or rate of bytes being |
| | | | moved into a cloud storage location |
| Egress | Outgoing data | Sent data | Amount or rate of bytes being |
| | | | moved out of a cloud storage |
| | | | location |
| Backup | Snapshot frequency | Incremental backup | Instantaneous state of a virtualized |
| | | | entity or group of virtualized entities |

The foregoing aspects, various corresponding terms, and common semantics are merely examples. Other aspects are possible, and in some cases, such aspects lend themselves to being represented in a user interface that abstracts a particular aspect based on some common semantic. An aspect can refer to any noun or verb or adjective or adverb or property or parameter (e.g., a federated property, a federated parameter, etc.) as may be pertinent to a virtualization system. In example deployments, properties or parameters that are shared, at least in part, between two or more cloud deployments (e.g., federated cloud properties, federated cloud parameters, etc.) may comprise one or more physical topology characteristics and/or one or more physical infrastructure characteristics. Similarly, certain deployments include properties or parameters that comprise one or more logical topology characteristics (e.g., a virtual execution environment boundary such as the footprint of a virtual machine) and/or one or more logical infrastructure characteristics (e.g., a virtual storage boundary such as the footprint of a virtual disk).

The foregoing discussion of FIG. 1B5 pertains to merely some possible embodiments and/or architectures. Many variations are possible and can be implemented in any environment.

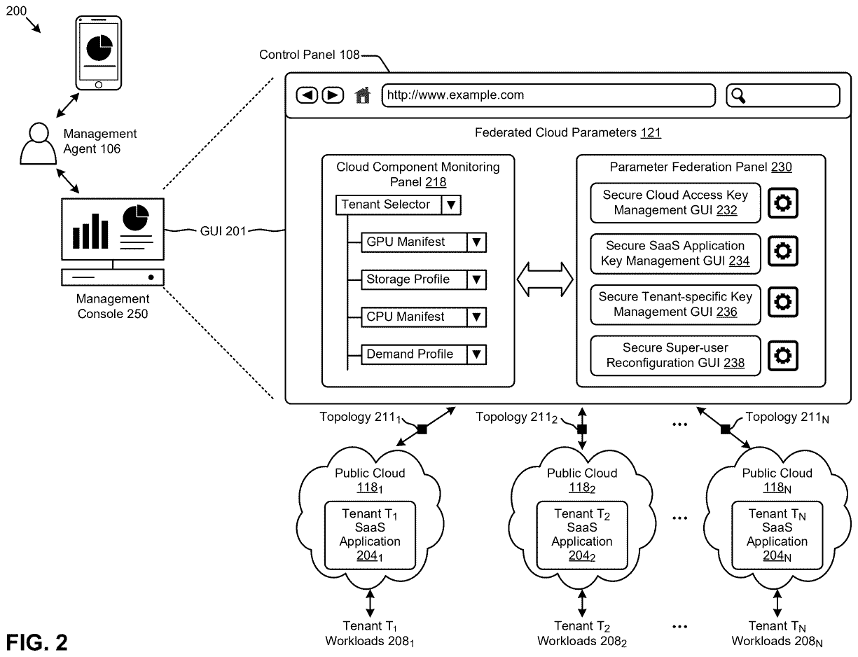

FIG. 2 is an architectural diagram 200 showing a user interface (UI) that amalgamates information derived from multiple independently operated clouds where each cloud hosts a software-as-a-service (SaaS) deployment for a particular tenant. As an option, one or more variations of the architecture FIG. 2 or any aspect thereof may be implemented in the context of the partitioning and functionality of the embodiments described herein and/or in any environment.

FIG. 2 is being presented to illustrate an alternative embodiment in which the advancements of the shown UI can be applied in heterogeneous cloud computing environments, including when said cloud computing environments instantiate various SaaS applications. In this embodiment, the architectural diagram includes multiple independently operated clouds (e.g., public cloud 118₁, public cloud 118₂, . . . , public cloud 118_{N}). Each public cloud hosts a corresponding tenant (e.g., tenant T₁, tenant T₂, . . . , tenant T_{N}) running its own instance of a SaaS application (e.g., SaaS application 204₁, SaaS application 204₂, . . . , SaaS application 204_{N}), while maintaining respective tenant-specific workloads (e.g., workloads 208₁, workloads 208₂, . . . , workloads 208_{N}).

However, in legacy approaches, management agent 106 lacks visibility into the underlying cloud infrastructures and associated topology. This lack of visibility prevents the management agent from performing proactive governance and lifecycle-management administrative tasks 122 (e.g., monitoring 123, security/compliance 125, data integrity 127, on-the-fly reconfiguration 129, storage demands profiling 131, licensing/billing 133).

To further explain, consider the following example: A common SaaS application, such as a shared accounts receivable application (e.g., NetSuite AR) is used by tenant T₁ (e.g., Costco), tenant T₂ (e.g., Walmart), . . . , tenant T_{N} (e.g., Ulta), yet each tenant operates within its own unique workload (e.g., workloads 208₁, workloads 208₂, . . . , workloads 208_{N}). While access to the specific financial data of each tenant inputs is not needed by the management agent, visibility into the underlying infrastructure and topology is required to provide targeted support for each tenant. The technique disclosed herein provides this visibility while preserving strict tenant isolation.

As illustrated, interrogation occurs between control panel 108 and each public cloud occupied by the tenants, and the collected information (e.g., metadata) is then amalgamated into a file (e.g., cluster summary file).

As can now be understood, the foregoing user interface provides visibility to infrastructure resource demands and/or licensing demands made by processes that are situated within the infrastructure. In some embodiments, the foregoing user interface provides visibility to infrastructure resource demands and/or licensing demands made by processes that are situated within any of the hierarchically-organized tenant partitions.

Because this amalgamated data is stored in a structured object format, it can be retrieved, analyzed, and updated by the control panel 108. Based on this structured data, an infrastructure-aware layer and a topology-aware layer are generated and applied to the individual clouds. These layers provide federated visibility and control over the heterogeneous SaaS deployments, thereby enabling improvements such as unified tenant management, workload organization, resource allocation, and hierarchical tenant mapping.

This enhances known legacy approaches and enables various improvements (e.g., tenant management and organization, resource allocation). Additionally, the advancement enables mapping of specific tenants, allowing targeted support for each tenant (e.g., apply licenses, renew terms of service, migrate from one place to another, etc.) to be provided by the management agent.

Various embodiments can be derived from the foregoing. Specifically, in one embodiment, a graphical user interface 201 consists of a first screen device (e.g., cloud computing monitoring panel 218) that identifies two or more tenants (e.g., via the tenant selector widget as shown) and/or two or more heterogeneous cloud infrastructures; and a second screen device (e.g., parameter federation panel 230) that comprises one or more federated cloud parameters 121, wherein the one or more federated cloud parameters are derived based on analysis of both of the two or more tenant topologies (e.g., topology 211₁, topology 211₂, . . . , topology 211_{N}) that in turn derive from the two or more heterogeneous cloud infrastructures (e.g., public cloud 118₁, public cloud 118₂, . . . , public cloud 118_{N}). Such one or more federated cloud parameters derive from two or more heterogeneous cloud infrastructures. Moreover, the one or more federated cloud parameters are configured to describe two or more respective cloud infrastructure topologies (e.g., topology 211₁, topology 211₂, . . . , topology 211_{N}).

In some cases, the user interface shows one or more federated cloud parameters that comprise an identification of two or more tenants (e.g., tenant T₁, tenant T₂, . . . , tenant T_{N}). In some cases, it may happen that the federated cloud parameters comprise either or both a physical topology characteristic or a physical infrastructure characteristic. Similarly, it may happen that the federated cloud parameters comprise either a logical topology characteristic or a logical infrastructure characteristic, or both. Further, a UI such as depicted in FIG. 2 supports user interaction over aspects (e.g., federated cloud parameters) of a first tenant and a second tenant. More particularly, (1) a first set of one or more virtualization system entities are presented in a first portion of the user interface when a first tenant is selected and (2) a second set of one or more virtualization system entities on second cloud infrastructure are presented in a second portion of the user interface when a second tenant is selected.

Such a UI can be instantiated on any sort of computing device that supports a user interface, including a management console 250 or a mobile device operated by a management agent 106. Strictly as an example, one possible method for configuring a graphical user interface screen involves a two-step process of: (1) instantiating a first screen device (e.g., cloud component monitoring panel 218) that identifies two or more heterogeneous cloud infrastructures, and (2) instantiating a second screen device (e.g., parameter federation panel 230) that comprises one or more federated cloud parameters (e.g., secure cloud access key management GUI 232, secure SaaS application key management GUI 234, secure tenant-specific key management GUI 236, and secure super-user reconfiguration GUI 238), wherein the one or more federated cloud parameters are derived based on analysis of two or more topologies that in turn derive from the two or more heterogeneous cloud infrastructures.

The foregoing discussion of FIG. 2 pertains to merely some possible embodiments. Many variations are possible and can be implemented in any environment.

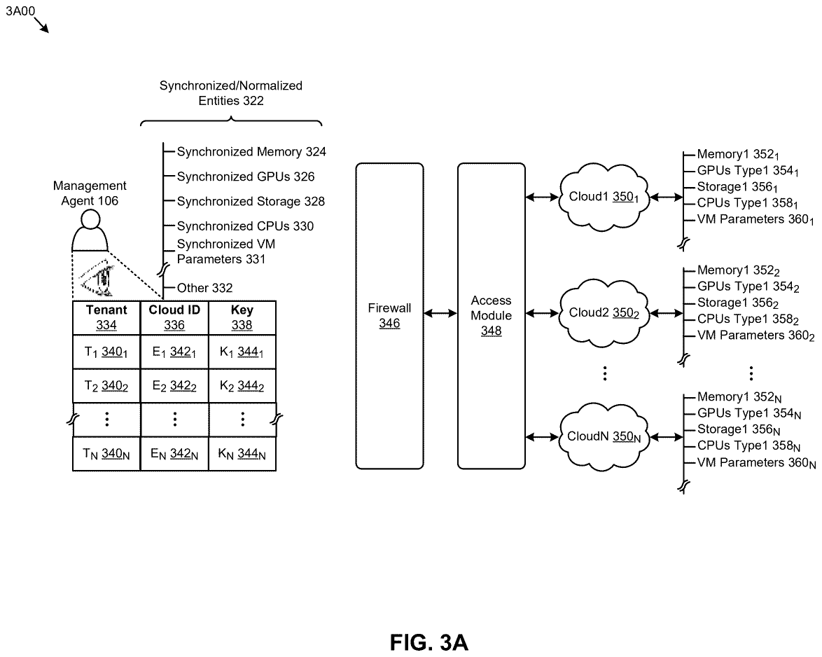

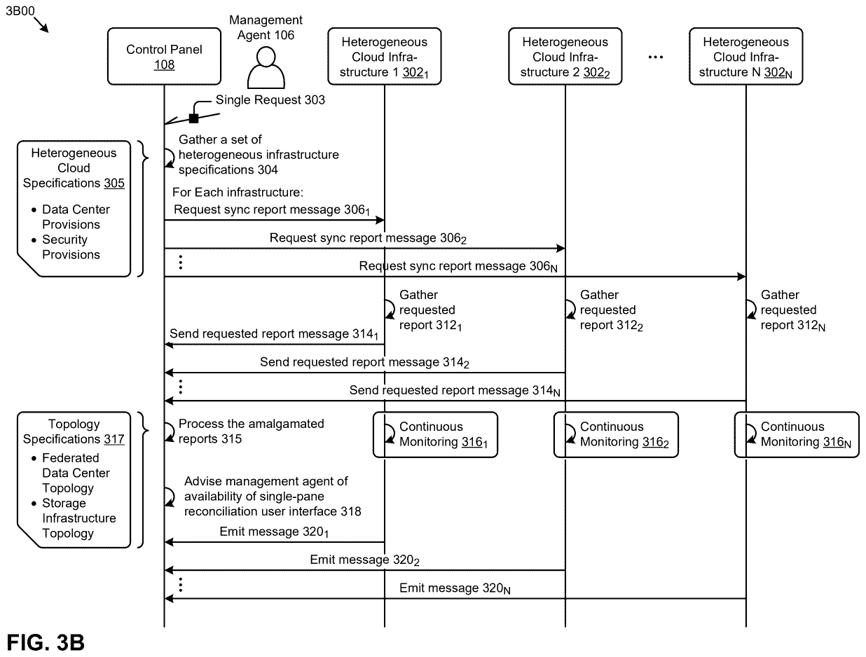

FIG. 3A is an architectural diagram 3A00 that includes a representation of a heterogeneous cloud information gathering technique where the cloud hosts a virtualization system as used in systems that facilitate lifecycle management of computing system deployments across multiple heterogenous computing infrastructures. As an option, one or more variations of heterogeneous cloud information gathering technique of FIG. 3A00 or any aspect thereof may be implemented in the context of the architecture and functionality of the embodiments described herein and/or in any environment.

The figure is being presented to illustrate how heterogeneous cloud information may be collected from virtualization system-based cloud deployments and subsequently organized into a data structure containing synchronized/normalized entities 322. These synchronized/normalized entities enable unified oversight of multiple virtualized environments, even when such environments operate under different hypervisors, infrastructure configurations, or resource hierarchies across public and private cloud systems.

As shown, FIG. 3A illustrates an embodiment in which information is collected from heterogeneous cloud deployments (e.g., cloud1 350₁, cloud2 350₂, . . . , cloudN 350_{N}), which are subsequently organized in a manner that enables a cloud-computing vendor to provide management and support from a single graphical user interface GUI. In one embodiment, the technique operates as discussed infra.

Programmatic interrogation occurs between each cloud deployment and the cloud-computing vendor's platform (e.g., public cloud, private cloud, hybrid cloud, SaaS environment, etc.). During interrogation, the management stack collects infrastructure-level characteristics of the underlying virtualization systems. These characteristics include, but are not limited to, memory resources (e.g., memory1 352₁, memory2 352₂, . . . , memoryN 352_{N}), graphics processing resources (e.g., GPUs type1 354₁, GPUs type1 354₂, . . . , GPUs typeN 354_{N}), storage resources (e.g., storage1 356₁, storage2 356₂, . . . , storageN 356_{N}), and computer processing unit resources (e.g., CPUs type1 358₁, CPUs type1 358₂, . . . , CPUs typeN 358_{N}). In addition, each cloud exposes virtual-machine parameters (e.g., VM parameters 360₁, VM parameters 360₂, . . . , VM parameters 360_{N}), which may include VM memory allocation, VM storage mappings, VM network profiles, and any configuration data required to understand VM topology and performance characteristics.

However, due to the presence of firewall 346, direct real-time access to these parameters is restricted. The firewall 346 enforces a trust boundary that protects tenant infrastructure while simultaneously limiting the cloud-computing vendor's visibility into operational states. Tenants authenticate into the cloud vendor's platform via access module 348, which mediates communications through the firewall.

To safely enable visibility while preserving tenant security, the disclosed technique leverages tenant-driven authentication flows. When a tenant logs into a service (e.g., a SaaS environment or public-cloud interface AWS, etc.) via interaction with the access module, a control panel managed by management agent 106 initiates interrogation of the heterogeneous infrastructures (e.g., cloud computing deployments). This is because the interrogation causes each cloud deployment to self-identify, thereby providing a unique identifier and corresponding secure key.

Once self-identification occurs, a key is provided to the tenant by the management agent, thus allowing traversal of the firewall. The key—stored later in column key 338—allows the cloud vendor to retrieve and amalgamate infrastructure-level metadata across the multiple cloud deployments. The amalgamated data is then stored and structured (e.g., as an object structure) in a manner accessible to the control panel. Based on this aggregated information, an infrastructure-aware layer and a topology-aware layer are generated and applied to the management agent's cloud. These layers enable creation and maintenance of the synchronized/normalized entities, which may include but are not limited to, synchronized memory 324, synchronized GPUs 326, synchronized storage 328, synchronized CPUs 330, synchronized VM parameters 331, and any additional synchronized entity data (other 332).

The synchronized/normalized entities are stored in a multi-column structures (e.g., a data matrix or database, etc.) that supports tenant recognition and cross-cloud federation. As illustrated, a first column tenant 334 stores the identity of each tenant (e.g., tenant T₁ 340₁, tenant T₂ 340₂, . . . , tenant T_{N} 340_{N}) and, optionally, its associated departments or sub-units.

A second column, Cloud ID 336 (e.g., cloud ID E₁ 342₁, cloud ID E₂ 342₂, . . . , cloud ID EN 342_{N}) stores unique identifiers for the corresponding cloud deployments, allowing the system to associate synchronized entity data with the correct underlying infrastructure. A third column, key 338 (e.g., key K₁ 344₁, key K₂ 344₂, . . . , key K_{N} 344_{N}), stores secure access keys or cryptographic tokens used for authenticated retrieval of cloud-specific data.

Mapping of specific tenants to specific cloud-deployments—enabled through the infrastructure-aware layer and topology-aware layer—allows the management agent to provide targeted lifecycle-management administrative services (e.g., applying licenses, renewing of terms of service, initiating workload migration from one place to another, etc.). In particular, the synchronized/normalized entities empower the management agent to exercise federated control over multiple heterogeneous virtualized infrastructures, enabling improvements such as tenant-level organization, resource allocation, cost optimization, and VM-level lifecycle management.

The foregoing discussion of FIG. 3A pertains to merely some possible embodiments and/or ways to implement a heterogeneous cloud information gathering technique. Many variations are possible, for example, the heterogeneous cloud information gathering technique as comprehended in the foregoing can be implemented in any environment and/or using any protocol, one example of which is shown and described as pertains to FIG. 3B.

FIG. 3B is a protocol diagram that implements a heterogeneous cloud information gathering technique where the cloud hosts a virtualization system 3B00 as used in systems that facilitate lifecycle management of computing system deployments across multiple heterogenous computing infrastructures. As an option, one or more variations of heterogeneous cloud information gathering technique where the cloud hosts a virtualization system 3B00 or any aspect thereof may be implemented in the context of the architecture and functionality of the embodiments described herein and/or in any environment.

FIG. 3B is presented to illustrate how a heterogeneous cloud information-gathering technique operates in an environment where a single management agent avails of a protocol that programmatically interacts with multiple heterogeneous infrastructures. More specifically, the technique shown in FIG. 3B allows the management agent to retrieve topology and infrastructure information from several independent cloud infrastructures based on a single request, without requiring the management agent to issue multiple follow-up API calls or protocol messages. This reduces administrative overhead and eliminates unnecessary network chatter.

As shown, protocol diagram 3B00 includes control panel 108 and multiple heterogeneous infrastructures (e.g., heterogeneous cloud infrastructure 1 302₂, heterogeneous cloud infrastructure 2 302₂, and heterogeneous cloud infrastructure N 302_{N}). The protocol begins when a single request 303 is issued to the control panel. As an example, a management agent might select infrastructure topology from a graphical user interface, which results in the dispatch of an event (e.g., single request 303).

In response to this event, control panel 108 performs operation 304 (gather a set of heterogeneous infrastructure specifications), during which it may consult heterogeneous cloud specifications 305, which specifications may include specification of data center provisions, specification of security provisions, or specification of other heterogenous infrastructure provisions. Examples of characteristics defined in the heterogeneous cloud specifications may include cloud provider identifiers, region or availability-zone layouts, hypervisor types, compute-cluster identifiers, storage-tier designations, or other cloud-specific provisions that inform how each infrastructure is to be configured and/or interrogated.

Once operation 304 to gather a set of heterogeneous infrastructure specifications is performed, the control panel issues message 306₁, message 306₂, . . . , message 306_{N} (request sync report), to each cloud infrastructure. These messages request that each infrastructure produce an up-to-date synchronized topology and resource state report. For example, message 306₁ may instruct heterogeneous cloud infrastructure 1 302₁ to report its current VM placements, available GPU capacity, or storage utilization trends.

Upon receiving a respective sync report request, each heterogeneous infrastructure performs operation 312₁, operation 312₂, . . . , operation 312_{N} (gather requested report), during which time the infrastructure retrieves its own local state. For instance, cloud infrastructure 2 302₂ might gather a list of VM parameters, active hosts, recent node failures, or recently updated storage policies. After completing operation 312₁, operation 312₂, . . . , operation 312_{N}, each infrastructure transmits its results back to the control panel through message 314₁, message 314₂, . . . , message 314_{N} (send requested report). These reports may include, but are not limited to, current memory utilization, available GPU types, hypervisor performance counters, node-health summaries, VM migration recommendations, storage throughput or latency, infrastructure usage reports (e.g., utilization or idle time reports), or license usage reports (e.g., covering any of a wide variety of software and/or hardware usage, and/or licensed cloud resource usage, etc.).

Upon receiving all sync reports, the control panel performs operation 315 (process the amalgamated reports). Operation 315 refers to the act performed of processing the amalgamated reports. During this operation, the control panel normalizes CPU metrics, GPU capabilities, memory availability, storage configurations, and VM parameter formats from each cloud into a unified model. Operation 315 to process the amalgamated reports produces a federated topology, represented in the figure as topology specifications 317, which may include federated data center topology, storage infrastructure topology, or other multi-cloud reconciliation outputs.

Meanwhile, independent of operation 315 to process the amalgamated reports, each heterogeneous infrastructure continues to perform operation 3161, operation 3162, . . . , operation 316N (continuous monitoring). Continuous monitoring includes observing for any infrastructure-level change events such as a compute node going offline, a storage pool being rebalanced, VM migration thresholds being triggered, GPU availability changing due to tenant load, hypervisor patching, or maintenance cycles.

If such a change is detected, the infrastructure emits message 320₁, message 320₂, . . . , message 320_{N}, which notify the control panel of the updated conditions. For example, emit message 320₂ might indicate that a new VM cluster has appeared in cloud infrastructure 2 302₂ after a tenant scaled out, or that storage tiering behavior has changed in cloud infrastructure N 302_{N}.

Following successful processing of the amalgamated reports in operation 315, the control panel performs operation 318 (advise management agent of availability of single-pane reconciliation user interface). This operation notifies the management agent 106 that a fully reconciled view—across all cloud infrastructures—is now available for display. A single-pane user interface may include consolidated topology diagrams, performance summaries, VM inventories, and cross-cloud recommendations.

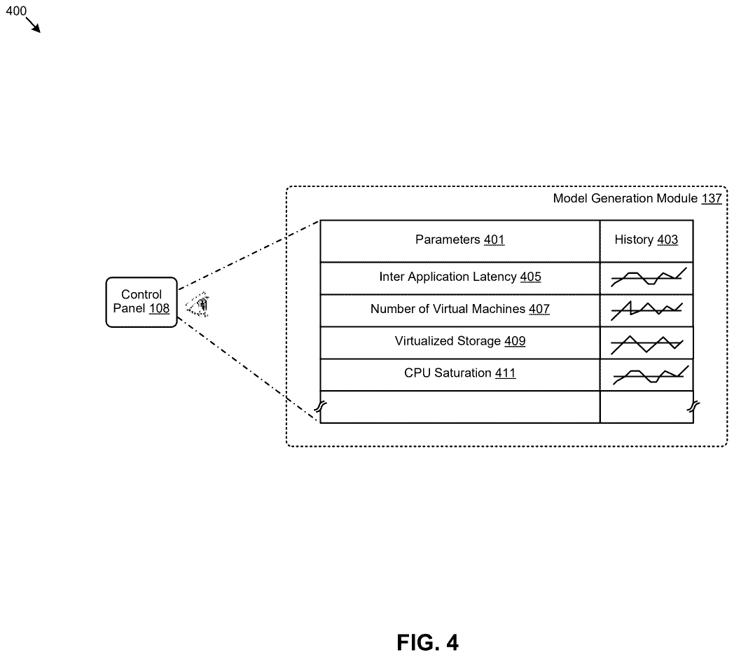

The foregoing discussion of FIG. 3B pertains to merely some possible embodiments and/or ways to implement a heterogeneous cloud information gathering technique. Many variations are possible, for example, the heterogeneous cloud information gathering technique as comprehended in the foregoing can be implemented in any environment, one example of which is shown and described as pertains to FIG. 4.

FIG. 4 depicts an example model generation engine 400 showing parameterized performance and configuration data, including sparkline-style historical trendlines, as produced by a tenant-isolated model generation engine. As an option, one or more variations of FIG. 4 or any aspect thereof may be implemented in the context of the architecture and functionality of the embodiments described herein and/or in any suitable environment.

FIG. 4 is presented to illustrate an embodiment in which a model generation engine (e.g., model generation 137) produces structured, tenant-isolated topology and performance representations suitable for use by management agent 106 as described with respect to FIG. 1B4. In this embodiment, a model generation engine is introduced into the architecture as a component of the heterogeneous cloud communication facility. The model generation engine consumes topology information (e.g., topology data 148₁, topology data 148_{N}) and normalized, infrastructure-specific information that has been discovered and synchronized across multiple heterogeneous clouds. Based on this synchronized information, the model generation engine constructs a tenant-isolated model that the management agent may use to evaluate conditions and propose remediation actions without breaching tenant boundaries.

The model shown in FIG. 4 includes a set of parameters 401 associated with a tenant's deployment such as inter-application latency 405, number of virtual machines 407, virtualized storage 409, CPU saturation 411, and any other parameter deemed relevant to performance assessment. Each parameter is accompanied by a corresponding sparkline-style trendline shown under history 403. These sparklines capture rolling time-series data and allow the management agent, through the control panel, to recognize emerging performance issues, degradation patterns, or demand-driven growth trends at a glance. As with all components of the heterogeneous cloud communication facility, the model generation engine maintains strict tenant isolation, i.e., each tenant's parameter set is generated, stored, and evaluated independently and without exposing any tenant data, proprietary logic, or tenant application content.

To illustrate the operation of the model generation engine, consider again the ride-hailing example described with respect to FIG. 1B4. As the number of drivers and riders increases in a newly launched geographic region, the heterogeneous cloud communication facility observes increases in network traffic, compute-instance utilization, and inter-application latency. The model generation engine captures these evolving conditions as parameterized values and sparkline histories within the corresponding tenant's topology model. These trendlines allow the management agent to detect patterns, such as rising latency or approaching resource saturation, and to evaluate potential remediation actions such as scaling additional server-side instances of the ride-hailing service or relocating the service to a data center nearer the new city. These determinations are made based on infrastructure-level and performance-level observations reflected in the model, thereby enabling informed, privacy-preserving control decisions.

The foregoing discussion of FIG. 4 pertains to merely some possible embodiments. Many variations are possible and can be implemented in any environment.

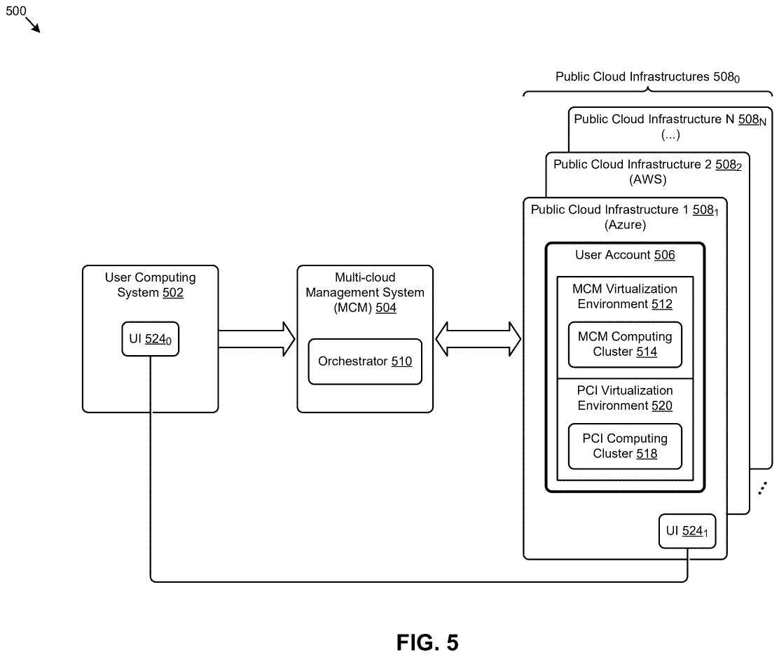

FIG. 5 depicts a high-level block diagram of a system 500 for bringing up a computing cluster on any one of a plurality of public cloud infrastructures, according to one disclosed embodiment as illustrated. The system includes user computing system 502 of a user intending to bring up a multi-cloud management system computing cluster 514 on one of public cloud infrastructures. The user computing system 502 is typically in network communication with a multi-cloud management system (shown as MCM 504), which is configured to receive computing cluster configurations and/or specifications from the user computing system according to user input. For example, a user interface may be installed on the user computing system, or the user computing system can access a web-based (e.g., browser based) user interface of MCM 504.

The MCM 504 may be a private computing system such as an on-premises computing system of the user separate from the user computing system, a private cloud computing system provided by a platform as a service (PAAS) provider, or other suitable computing system. The detailed description of the embodiments will be described with the MCM 504 being a private cloud computing system provided by a PAAS provider, with the understanding that MCM 504 can be any suitable computing system. In such a case, the user will typically have an MCM account for a subscription or license to use the PAAS comprising the MCM 504, allowing the user to use the MCM 504 to bring up a computing cluster on public cloud infrastructures 508₀ (e.g., public cloud infrastructure 1 508₁ (Azure), public cloud infrastructure 2 508₂ (AWS), . . . , public cloud infrastructure N 508_{N} ( . . . )). The user also has one or more users' PCI account(s) for a subscription or license to use one or more of the respective public cloud infrastructures on which the computing cluster will be brought up by the MCM 504. The user selects one of the public cloud infrastructures (e.g., public cloud infrastructure 1 508₁ (Azure), public cloud infrastructure 2 508₂ (AWS), . . . , public cloud infrastructure N 508_{N}, etc.), for which it has a service subscription. For example, the selection of one public cloud infrastructure may be part of the user's profile in its account on the MCM, or the selection can simply be a setting on the MCM which is selected when a user instructs the MCM to bring up a computing cluster on the selected public cloud infrastructure.

MCM 504 includes orchestrator 510. The orchestrator 510 is a software module of the MCM 504 which is configured to receive computing cluster specifications input from the user computing system, and then determine and transmit bring-up commands to a selected one of the public cloud infrastructures to bring up MCM computing cluster 514 on the public cloud infrastructure. In one aspect, the bring-up commands may include only idempotent operations. An operation is “idempotent” if it can be carried out any number of times until it is successful, and even if the operation fails, it can be repeated at a later time and/or under a different set of conditions, at which time or under which different set of conditions the idempotent operation can successfully execute. Alternatively, the bring-up commands may comprise only atomic operations. An operation is “atomic” when the operation either completely, successfully executes or, if not, the operation has no effect on the system. In another embodiment, the bring-up commands may comprise only idempotent operations and/or atomic operations.

As illustrated in one innovative aspect of the system, the MCM 504 brings-up an MCM computing cluster 514 in user account 506 on public cloud infrastructure 1 508₁ (Azure), such as a user's PCI account. Although certain embodiments described herein utilize a user's PCI account, it is understood that the account may be any suitable account on the public cloud infrastructure 1 508₁ (Azure). The figure shows the MCM computing cluster being brought up on public cloud infrastructure 1, just as an example, as the MCM computing cluster could be brought up on any of public cloud infrastructure (e.g., public cloud infrastructure 1 508₁ (Azure), public cloud infrastructure 2 508₂ (AWS), . . . , public cloud infrastructure N 508_{N} ( . . . )). The MCM computing cluster may include one or more nodes, each comprising a respective virtual machine. FIG. 5 shows that the MCM computing cluster is brought up in an MCM virtualization environment 512, which is generated by MCM. FIG. 5 also depicts that the user may bring up, within the same user's account, PCI computing cluster 518 within a public cloud infrastructure (PCI) virtualization environment of public cloud infrastructure 1. For example, a cloud virtualization module of the public cloud infrastructure is utilized by the user using a user interface 5241 of public cloud infrastructure 1 to bring up the PCI computing cluster 518 within the PCI virtualization environment 520.

The orchestrator 510 also includes a remote API execution module. The remote API execution module includes a library of API calls comprising bring-up commands for each respective public cloud infrastructure. For example, the library of API calls may include API calls for Azure, API calls for AWS, and API calls for some other cloud. The library may also include API calls for a hypervisor, such as ACROPOLIS™ hypervisor (AHV), available from Nutanix, Corp., San Jose, California.

The single orchestrator is configured to bring up a computing cluster on any of the plurality of public cloud infrastructures 512. The single orchestrator 510 is configured to receive generic cluster specifications (e.g., requirements and/or instructions) from a user for a computing cluster. In other words, the generic cluster specifications are not specific to any particular one of public cloud infrastructures. For instance, a user interface could be configured to be generic such that it receives input instructions (e.g., specification for a computing cluster) from a user for instantiating a computing cluster that are not specific to any of the plurality of public cloud infrastructures. The user interface also provides generic instructions to the orchestrator, which are also generic, and not specific to any of the plurality of public cloud infrastructures. The orchestrator is configured to receive the generic specifications for the computing cluster, and generates a cluster specification and determines bring-up commands (e.g., API calls and other instructions) for a specific, selected public cloud infrastructure of the plurality of public cloud infrastructures, instead of having a different orchestrator configured for each respective public cloud infrastructure, such as a first orchestrator for public cloud infrastructure 1 (e.g., Azure), a second orchestrator for public cloud infrastructure 2 (e.g., AWS), and so on.

The multi-cloud management system 504 is also configured to load an orchestrator agent onto the selected public cloud infrastructure. The orchestrator agent is configured to execute bring-up commands and to communicate cluster status data to the orchestrator. For example, an orchestrator agent may be configured to access metadata stored within a metadata store regarding the status of the bring-up of the computing cluster on the public cloud infrastructure (e.g., public cloud infrastructure 1 508₁ (Azure), public cloud infrastructure 2 508₂ (AWS), . . . , public cloud infrastructure N 508_{N} ( . . . )), and then generate and transmit a cluster status message, including the cluster status data, to the orchestrator.

The orchestrator 510 is configured to receive the cluster status data from the orchestrator agent, analyze the cluster status data, and determine cluster bring-up commands to bring up the computing cluster according to the cluster specification.

Each public cloud infrastructure (e.g., public cloud infrastructure 1 508₁ (Azure), public cloud infrastructure 2 508₂ (AWS), . . . , public cloud infrastructure N 508_{N} ( . . . )) may also include a public cloud infrastructure (PCI) management module. The PCI management module is configured to bring up PCI computing cluster 518 within PCI virtualization environment. The computing cluster may comprise one or more nodes, each comprising a respective virtual machine (VM).

In use, a user logs into user account 506. Subsequently, the MCM logs into the user's PCI account on the public cloud infrastructure (e.g., public cloud infrastructure 1 508₁ (Azure), public cloud infrastructure 1 508₂ (AWS), . . . , public cloud infrastructure 1 508_{N}), for example, by using the user's credentials. In a step-wise implementation, the public cloud infrastructure acknowledges the login. Further steps may be performed at any suitable point in the method prior to the MCM sending instructions to the public cloud infrastructure.

In the same or in a further step, the user utilizes user computing system 502 to input instructions (e.g., generic instructions not specific to any of the public cloud infrastructures 508₀) into user interface 5240 to instantiate a computing cluster on the selected public cloud infrastructure and configure the cluster having a certain set of specifications. The user interface provides the instructions (e.g., generic instructions) to the orchestrator.

The user interface provides the instructions and specifications (e.g., generic instructions and specifications not specific to any particular public cloud infrastructures 508₀) to the orchestrator. The orchestrator automation generates a cluster specification and determines public cloud infrastructure-specific API calls for the specific public cloud infrastructures to bring up a computing cluster according to the cluster specification.

The MCM 504 loads the orchestrator agent onto the public cloud infrastructure in the user's account within the MCM virtualization environment 512. In other words, the MCM provisions a node on the public cloud infrastructure in the user's account and loads the orchestrator agent onto the node.

The orchestrator automation then executes API calls from the API library for the selected public cloud infrastructure. The MCM then sends the first public cloud infrastructure-specific bring-up commands to the orchestrator agent on the public cloud infrastructure based on the API calls to bring up the MCM computing cluster in the user's account on the public cloud infrastructure. The bring-up commands may be idempotent operations and/or atomic operations, which may be repeated until such bring-up commands are successful.

In a further subsequent step, the orchestrator agent determines a configuration state and sends the configuration state indication to the MCM. The configuration state indication includes information corresponding to the status of the computing cluster being brought up on the public cloud infrastructure (e.g., public cloud infrastructure 1 508₁ (Azure), public cloud infrastructure 2 508₂ (AWS), . . . , public cloud infrastructure N 508_{N} ( . . . )). Next, the orchestrator automation analyzes the configuration state indication and determines updated API calls to bring up the computing cluster according to the cluster specification.

The needed steps of this approach may be repeated until the computing cluster is fully brought up according to the cluster specification, or the process is terminated, for example by a failure or error timeout or user intervention. Further details regarding ongoing management of virtualized entities in a virtualized system can be found in commonly-owned US Patent number U.S. Pat. No. 11,900,172 B2, titled “COMPUTING CLUSTER BRING-UP ON PUBLIC CLOUD INFRASTRUCTURES USING EXPRESSED INTENTS” filed on Jul. 29, 2022.

The foregoing discussion of FIG. 5 pertains to merely some possible embodiments and/or ways to implement any of the systems as contemplated herein. Many variations are possible and can be implemented in any environment.

### Additional Embodiments of the Disclosure

### Additional Practical Application Examples

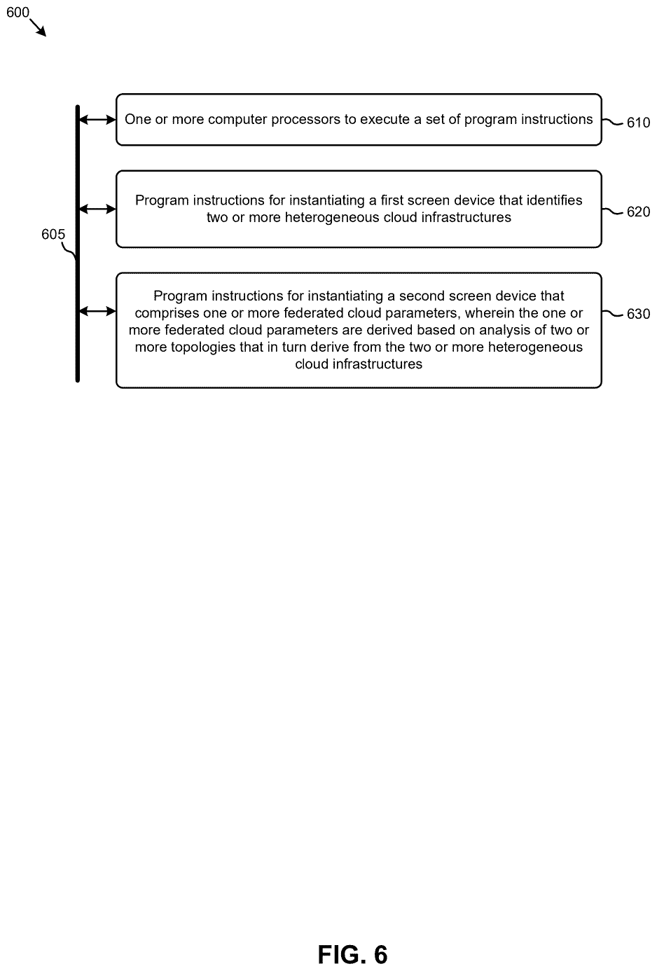

FIG. 6 depicts system components as arrangements of computing modules that are interconnected so as to facilitate one or more computer processors (module 610) to implement certain of the herein-disclosed embodiments.

FIG. 6 depicts a block diagram of a system for configuring a graphical user interface screen. As an option, system 600 may be implemented in the context of the architecture and functionality of the embodiments described herein. Of course, however, the system or any operation therein may be carried out in any desired environment.

The system 600 comprises a plurality of modules, a module comprising at least one processor and a memory, each connected to a communication link 605, and any module can communicate with other modules over communication link 605. The modules of the system can, individually or in combination, perform method steps within system 600. Any steps performed within system 600 may be performed in any order unless as may be specified in the claims.

As shown, system 600 implements a method for configuring a graphical user interface screen, the system 600 comprising modules for: instantiating a first screen device that identifies two or more heterogeneous cloud infrastructures (module 620); and instantiating a second screen device that comprises one or more federated cloud parameters, wherein the one or more federated cloud parameters are derived based on analysis of two or more topologies that in turn derive from the two or more heterogeneous cloud infrastructures (module 630).

FIG. 6 depicts a block diagram of a system to perform certain functions of a computer system. As an option, system 600 may be implemented in the context of the architecture and functionality of the embodiments described herein. Of course, however, the system 600 or any operation therein may be carried out in any desired environment.

The system 600 comprises at least one processor and at least one memory, the memory serving to store program instructions corresponding to the operations of the system. As shown, an operation can be implemented in whole or in part using program instructions accessible by a module. The modules are connected to a communication path 605, and any operation can communicate with any other operation over communication path 605. The modules of the system can, individually or in combination, perform method operations within system 600. Any operations performed within system 600 may be performed in any order unless as may be specified in the claims.

The shown embodiment implements a portion of a computer system, presented as system 600, comprising one or more computer processors to execute a set of program code instructions (module 610) and modules for accessing memory to hold program code instructions to perform: instantiating a first screen device that identifies two or more heterogeneous cloud infrastructures (module 620); instantiating a second screen device that comprises one or more federated cloud parameters, wherein the one or more federated cloud parameters are derived based on analysis of two or more topologies that in turn derive from the two or more heterogeneous cloud infrastructures (module 630).

### System Architecture Overview

### Additional System Architecture Examples

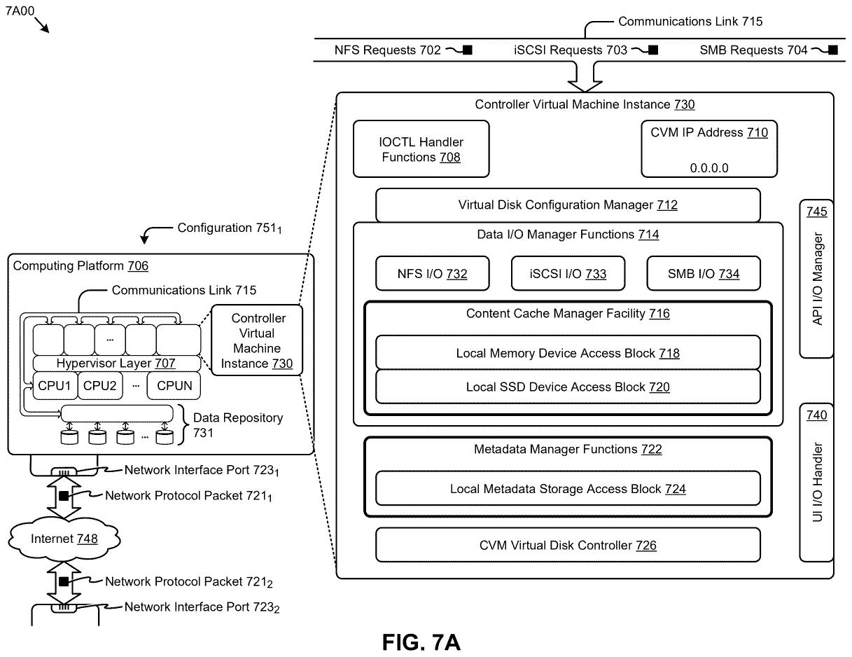

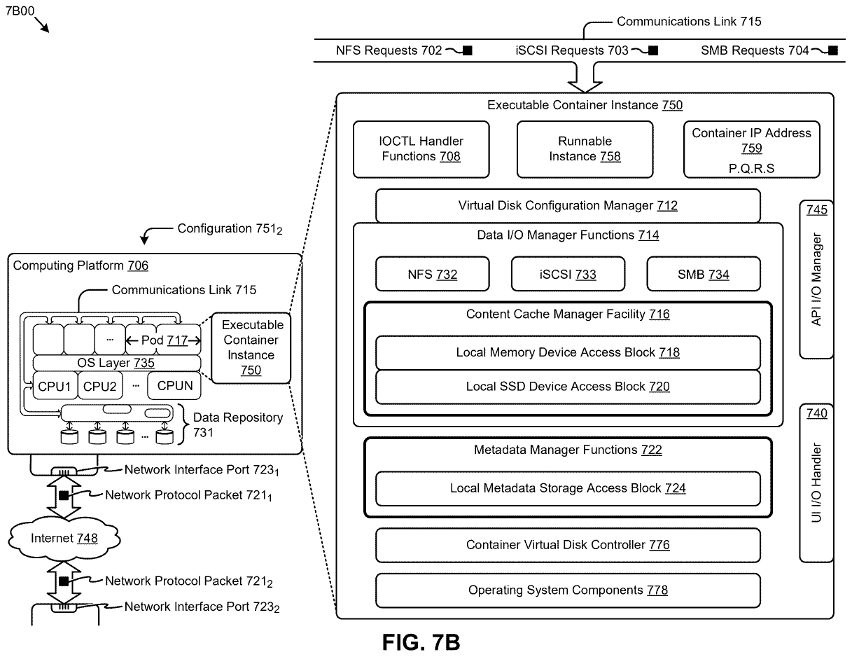

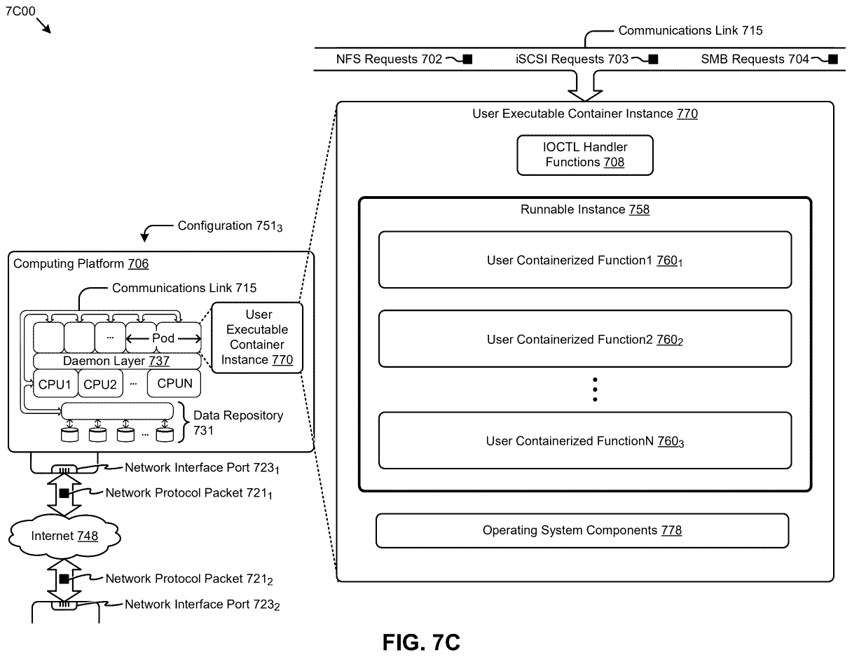

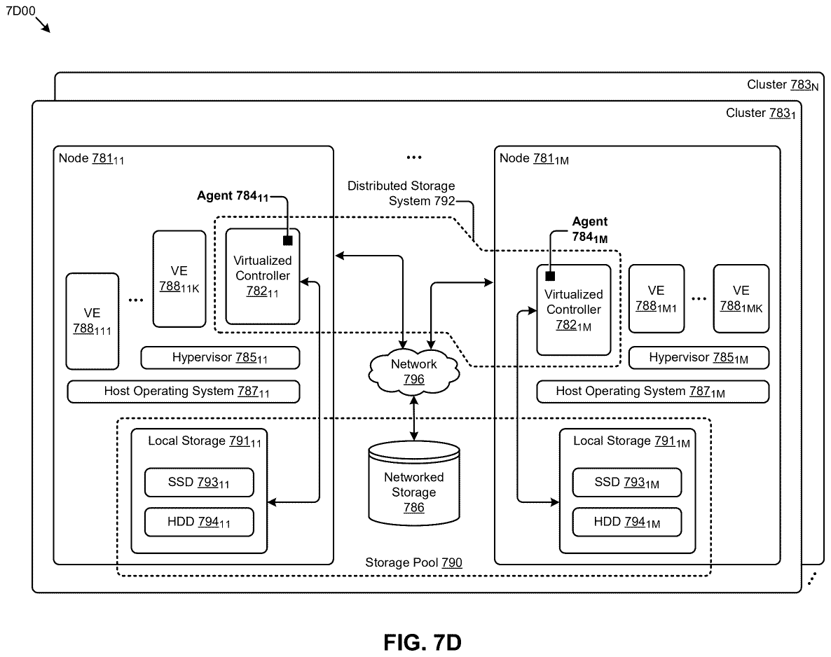

All or portions of any of the foregoing techniques can be partitioned into one or more modules and instanced within, or as, or in conjunction with, a virtualized controller in a virtual computing environment. Some example instances of virtualized controllers situated within various virtual computing environments are shown and discussed as pertains to FIG. 7A, FIG. 7B, FIG. 7C, and FIG. 7D.

FIG. 7A depicts a virtualized controller as implemented in the shown virtual machine architecture 7A00. The heretofore-disclosed embodiments, including variations of any virtualized controllers, can be implemented in distributed systems where a plurality of networked-connected devices communicate and coordinate actions using inter-component messaging.

As used in these embodiments, a virtualized controller is a collection of software instructions that serve to abstract details of underlying hardware or software components from one or more higher-level processing entities. A virtualized controller can be implemented as a virtual machine, as an executable container, or within a layer (e.g., such as hypervisor layer 707). Furthermore, as used in these embodiments, distributed systems are collections of interconnected components that are designed for, or dedicated to, storage operations as well as being designed for, or dedicated to, computing and/or networking operations.

Interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, computing and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system (OS) virtualization techniques are combined.

As shown, virtual machine architecture 7A00 comprises a collection of interconnected components suitable for implementing embodiments of the present disclosure and/or for use in the herein-described environments. Moreover, virtual machine architecture 7A00 includes a controller virtual machine instance 730 in configuration 751₁ that is further described below as pertaining to implementation of such a controller virtual machine instance 730. Configuration 751₁ supports virtual machine instances that are deployed as user virtual machines, or controller virtual machines or both. Such virtual machines interface with a hypervisor layer (as shown). Some virtual machines are configured to process storage inputs or outputs (I/O or IO) as received from any or every source within the computing platform. An example implementation of such a virtual machine that processes storage I/O is depicted as 730.

In this and other configurations, a controller virtual machine instance receives block I/O storage requests as network file system (NFS) requests in the form of NFS requests 702, and/or internet small computer system interface (iSCSI) block IO requests in the form of iSCSI requests 703, and/or Samba file system (SMB) requests in the form of SMB requests 704. The controller virtual machine (CVM) instance publishes and responds to an internet protocol (IP) address (e.g., CVM IP address 710). Various forms of input and output can be handled by one or more IO control (IOCTL) handler functions (e.g., IOCTL handler functions 708) that interface to other functions such as data IO manager functions 714 and/or metadata manager functions 722. As shown, the data IO manager functions can include communication with virtual disk configuration manager 712 and/or can include direct or indirect communication with any of various block IO functions (e.g., NFS 732, iSCSI 733, SMB 734, etc.).

In addition to block IO functions, configuration 751₁ supports input or output (IO) of any form (e.g., block IO, streaming IO) and/or packet-based IO such as hypertext transport protocol (HTTP) traffic, etc., through either or both of a user interface (UI) handler such as UI IO handler 740 and/or through any of a range of application programming interfaces (APIs), possibly through API IO manager 745.

Communications link 715 can be configured to transmit (e.g., send, receive, signal, etc.) any type of communications packet comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, the detail of controller virtual machine instance 730 includes content cache manager facility 716 that accesses storage locations, possibly including local dynamic random access memory (DRAM) (e.g., through local memory device access block 718) and/or possibly including accesses to local solid state storage (e.g., through local SSD device access block 720).

Common forms of computer readable media include any non-transitory computer readable medium, for example, floppy disk, flexible disk, hard disk, magnetic tape, or any other magnetic medium; compact disk read-only memory (CD-ROM) or any other optical medium; punch cards, paper tape, or any other physical medium with patterns of holes; or any random access memory (RAM), programmable read-only memory (PROM), erasable programmable read-only memory (EPROM), flash memory EPROM (FLASH-EPROM), or any other memory chip or cartridge. Any data can be stored, for example, in any form of data repository 731, which in turn can be formatted into any one or more storage areas, and which can comprise parameterized storage accessible by a key (e.g., a filename, a table name, a block address, an offset address, etc.). Data repository 731 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 724. The data repository 731 can be configured using CVM virtual disk controller 726, which can in turn manage any number or any configuration of virtual disks.

Execution of a sequence of instructions to practice certain embodiments of the disclosure are performed by one or more instances of a software instruction processor, or a processing element such as a central processing unit (CPU) or data processor or graphics processing unit (GPU), or such as any type or instance of a processor (e.g., CPU1, CPU2, . . . , CPUN). According to certain embodiments of the disclosure, two or more instances of configuration 751₁ can be coupled by communications link 715 (e.g., backplane, local area network, public switched telephone network, wired or wireless network, etc.) and each instance may perform respective portions of sequences of instructions as may be required to practice embodiments of the disclosure.

The shown computing platform 706 is interconnected to the Internet 748 through one or more network interface ports (e.g., network interface port 723₁ and network interface port 723₂). Configuration 751₁ can be addressed through one or more network interface ports using an IP address. Any operational element within computing platform 706 can perform sending and receiving operations using any of a range of network protocols, possibly including network protocols that send and receive packets (e.g., network protocol packet 721₁ and network protocol packet 721₂).

Computing platform 706 may transmit and receive messages that can be composed of configuration data and/or any other forms of data and/or instructions organized into a data structure (e.g., communications packets). In some cases, the data structure includes program instructions (e.g., application code) communicated through the Internet 748 and/or through any one or more instances of communications link 715. Received program instructions may be processed and/or executed by a CPU as it is received and/or program instructions may be stored in any volatile or non-volatile storage for later execution. Program instructions can be transmitted via an upload (e.g., an upload from an access device over the Internet 748 to computing platform 706). Further, program instructions and/or the results of executing program instructions can be delivered to a particular user via a download (e.g., a download from computing platform 706 over the Internet 748 to an access device).

Configuration 751₁ is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (LAN) and/or through a virtual LAN (VLAN) and/or over a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to lifecycle management of computing system deployments across multiple heterogenous computing infrastructures. In some embodiments, a module may include one or more state machines and/or combinational logic used to implement or facilitate the operational and/or performance characteristics pertaining to lifecycle management of computing system deployments across multiple heterogenous computing infrastructures.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of lifecycle management of computing system deployments across multiple heterogenous computing infrastructures). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to lifecycle management of computing system deployments across multiple heterogenous computing infrastructures, and/or for improving the way data is manipulated when performing computerized operations pertaining to implementation of a federated model for management of computing system deployments that span across multiple heterogenous computing infrastructures.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT” issued on Oct. 1, 2013, which is hereby incorporated by reference in its entirety.

FIG. 7B depicts a virtualized controller implemented by containerized architecture 7B00. The containerized architecture comprises a collection of interconnected components suitable for implementing embodiments of the present disclosure and/or for use in the herein-described environments. Moreover, the shown containerized architecture 7B00 includes an executable container instance 750 in configuration 7512 that is further described below as pertaining to executable container instance 750. Configuration 7512 includes an operating system layer (the shown OS layer 735) that performs addressing functions such as providing access to external requestors (e.g., user virtual machines or other processes) via an IP address 759 (e.g., “P.Q.R.S”, as shown). Providing access to external requestors can include implementing all or portions of a protocol specification, possibly including the hypertext transport protocol (HTTP or “http:”) and/or possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

An operating system layer (e.g., the shown OS layer 735) can perform port forwarding to any executable container (e.g., executable container instance 750). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a corresponding virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “Is”, “dir”, etc.). The executable container might optionally include operating system components 778, however such a separate set of operating system components need not be provided. As an alternative, an executable container can include runnable instance 758, which is built (e.g., through compilation and linking, or just-in-time compilation, etc.) to include any or all of any or all library entries and/or operating system (OS) functions, and/or OS-like functions as may be needed for execution of the runnable instance. In some cases, a runnable instance can be built with a virtual disk configuration manager, any of a variety of data IO management functions, etc. In some cases, a runnable instance includes code for, and access to, container virtual disk controller 776. Such a container virtual disk controller can perform any of the functions that the aforementioned CVM virtual disk controller 726 can perform, yet such a container virtual disk controller does not rely on a hypervisor or any particular host operating system so as to perform its range of functions.

In some environments, multiple executable containers can be collocated and/or can share one or more contexts. For example, multiple executable containers that share access to a virtual disk can be assembled into a pod 717 (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod). In various implementations a pod represents a set of running or runnable processes. A pod can be deployed as the lowest level executable unit of a containerized application. As used herein, a pod that is instanced within a node can be addressed by a local IP address.

FIG. 7C depicts a virtualized controller implemented by a daemon-assisted containerized architecture 7C00. The containerized architecture comprises a collection of interconnected components suitable for implementing embodiments of the present disclosure and/or for use in the herein-described environments. Moreover, the shown daemon-assisted containerized architecture includes a user executable container instance 770 in configuration 751₃ that is further described below as pertaining to user executable container instance 770. Configuration 751₃ includes a daemon layer 737 that performs certain functions of an operating system.

User executable container instance 770 comprises any number of user containerized functions (e.g., user containerized function1 760₁, user containerized function2 760₂, . . . , user containerized functionN 760₃). Such user containerized functions can execute autonomously or can be interfaced with or wrapped in a runnable object to create a runnable instance (e.g., runnable instance 758). In some cases, the shown operating system components 778 comprise portions of an operating system, which portions are interfaced with or included in the runnable instance and/or any user containerized functions. In this embodiment of a daemon-assisted containerized architecture, the computing platform 706 might or might not host operating system components other than operating system components 778. More specifically, the shown daemon might or might not host operating system components other than operating system components 778 of user executable container instance 770.

The virtual machine architecture 7A00 of FIG. 7A and/or the containerized architecture 7B00 of FIG. 7B and/or the daemon-assisted containerized architecture 7C00 of FIG. 7C can be used in any combination to implement a distributed platform that contains multiple servers and/or nodes that manage multiple tiers of storage where the tiers of storage might be formed using the shown data repository 731 and/or any forms of network accessible storage. As such, the multiple tiers of storage may include storage that is accessible over communications link 715. Such network accessible storage may include cloud storage or networked storage (NAS) and/or may include all or portions of a storage area network (SAN). Unlike prior approaches, the presently-discussed embodiments permit local storage that is within or directly attached to the server or node to be managed as part of a storage pool. Such local storage can include any combination of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term “vDisk” refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor or corresponding computer modules that manage the interactions between the underlying hardware and user virtual machines or containers that run client software.

Distinct from user virtual machines or user executable containers, a special controller virtual machine or a special controller executable container can be used to manage certain storage and I/O activities. Such a special controller virtual machine is referred to as a “CVM”, or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 7D depicts a distributed virtualization system in a multi-cluster environment 7D00. The shown distributed virtualization system is configured to be used to implement the herein disclosed techniques. Specifically, the distributed virtualization system of FIG. 7D comprises multiple clusters (e.g., cluster 783₁, . . . , cluster 783_{N}) comprising multiple nodes that have multiple tiers of storage in a storage pool. Representative nodes (e.g., node 781₁₁, . . . , node 781_{1M}) and storage pool 790 associated with cluster 783₁ are shown. Each node can be associated with one server, multiple servers, or portions of a server. The nodes can be associated (e.g., logically and/or physically) with the clusters. As shown, the multiple tiers of storage include storage that is accessible through a network 796, such as a networked storage 786 (e.g., a storage area network or SAN, network attached storage or NAS, etc.). The multiple tiers of storage further include instances of local storage (e.g., local storage 791₁₁, . . . , local storage 791_{1M}). For example, the local storage can be within or directly attached to a server and/or appliance associated with the nodes. Such local storage can include solid state drives (SSD 793₁₁, . . . , SSD 793_{1M}), hard disk drives (HDD 794₁₁, . . . , HDD 794_{1M}), and/or other storage devices.

As shown, any of the nodes of the distributed virtualization system can implement one or more user virtualized entities (VEs) such as the virtualized entity (VE) instances shown as VE 788₁₁₁, . . . , VE 788_{11K}, . . . , VE 788_{1M1}, . . . , VE 788_{1MK}, and/or a distributed virtualization system can implement one or more virtualized entities that may be embodied as a virtual machines (VM) and/or as an executable container. The VEs can be characterized as software-based computing “machines” implemented in a container-based or hypervisor-assisted virtualization environment that emulates underlying hardware resources (e.g., CPU, memory, etc.) of the nodes. For example, multiple VMs can operate on one physical machine (e.g., node host computer) running a single host operating system (e.g., host operating system 787₁₁, . . . , host operating system 787_{1M}), while the VMs run multiple applications on various respective guest operating systems. Such flexibility can be facilitated at least in part by a hypervisor (e.g., hypervisor instance 785₁₁, . . . , hypervisor instance 785_{1M}), which hypervisor instances are logically located between the various guest operating systems of the VMs and the host operating system of the physical infrastructure (e.g., node).

As an alternative, executable containers may be implemented at the nodes in an operating system-based virtualization environment or in a containerized virtualization environment. The executable containers comprise groups of processes and/or may use resources (e.g., memory, CPU, disk, etc.) that are isolated from the node host computer and other containers. Such executable containers directly interface with the kernel of the host operating system (e.g., host operating system 787₁₁, . . . , host operating system 787_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 790 by the VMs and/or the executable containers.

Multiple instances of such virtualized controllers can coordinate within a cluster to form the distributed storage system 792 which can, among other operations, manage the storage pool 790. This architecture further facilitates efficient scaling in multiple dimensions (e.g., in a dimension of computing power, in a dimension of storage space, in a dimension of network bandwidth, etc.).

A particularly-configured instance of a virtual machine at a given node can be used as a virtualized controller in a hypervisor-assisted virtualization environment to manage storage and I/O (input/output or IO) activities of any number or form of virtualized entities. For example, the virtualized entities at node 781₁₁ can interface with a controller virtual machine (e.g., virtualized controller 782₁₁) through hypervisor instance 785₁₁ to access data of storage pool 790. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 792. For example, a hypervisor at one node in the distributed storage system 792 might correspond to software from a first vendor, and a hypervisor at another node in the distributed storage system 792 might correspond to a second software vendor. As another virtualized controller implementation example, executable containers can be used to implement a virtualized controller (e.g., virtualized controller 782_{1M}) in an operating system virtualization environment at a given node. In this case, for example, the virtualized entities at node 781_{1M} can access the storage pool 790 by interfacing with a controller container (e.g., virtualized controller 782_{1M}) through hypervisor instance 785_{1M} and/or the kernel of host operating system 787_{1M}.

In certain embodiments, one or more instances of an agent can be implemented in the distributed storage system 792 to facilitate the herein disclosed techniques. Specifically, agent 784₁₁ can be implemented in the virtualized controller 782₁₁, and agent 784_{1M} can be implemented in the virtualized controller 782_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

Solutions attendant to implementing a federated model for management of computing system deployments that span across multiple heterogenous computing infrastructures can be brought to bear through implementation of any one or more of the foregoing techniques. Moreover, any aspect or aspects of the inexorable roll-out of more and more cloud offerings onto more and more different infrastructures can be implemented in the context of the foregoing environments.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A non-transitory computer readable medium having stored thereon a sequence of instructions which, when stored in memory and executed by a processor cause the processor to perform acts for managing a virtualized application deployment, the acts comprising:
deploying at least two tenant partitions, wherein a first one of the at least two tenant partitions is hosted on a first cloud infrastructure and wherein a second one of the at least two tenant partitions is hosted on a second cloud infrastructure;
accessing a first credentialing facility wherein an administrator is credentialed to provide access to a first set of one or more virtualization system entities on the first cloud infrastructure that hosts at least a first one of the at least two tenant partitions;
accessing a second credentialing facility wherein the administrator is credentialed to provide access to a second set of one or more virtualization system entities on the second cloud infrastructure, wherein the second set of one or more virtualization system entities has at least one difference from the first set of one or more virtualization system entities; and
a user interface wherein at least some aspects of the first set of one or more virtualization system entities on first cloud infrastructure are presented in a first portion of the user interface and wherein at least some aspects of the second set of one or more virtualization system entities on second cloud infrastructure are presented in a second portion of the user interface.

2. The non-transitory computer readable medium of claim 1, wherein the user interface provides visibility to infrastructure resource demands or licensing demands made by processes that are situated within at least one of a plurality of hierarchically-organized tenant partitions.

3. The non-transitory computer readable medium of claim 2, further comprising instructions which, when stored in memory and executed by the processor cause the processor to perform further acts of, emitting one or more infrastructure usage reports, or one or more license usage report that correspond to at least one of the plurality of hierarchically-organized tenant partitions.

4. The non-transitory computer readable medium of claim 2, wherein at least some of the at least two tenant partitions correspond to at least one of, different departments, different organizational functions, or different organizational activities.

5. The non-transitory computer readable medium of claim 2, wherein the first cloud infrastructure is heterogeneous to the second cloud infrastructure.

6. The non-transitory computer readable medium of claim 2, wherein a first one of the at least one of the hierarchically-organized tenant partitions is situated on the first cloud infrastructure, and wherein at least a second one of the at least one of the hierarchically-organized tenant partitions is situated on the second cloud infrastructure.

7. The non-transitory computer readable medium of claim 2, wherein one or more cloud parameters are shared by a first tenant on the first cloud infrastructure and a second tenant on the second cloud infrastructure.

8. The non-transitory computer readable medium of claim 1, wherein one or more cloud parameters describe at least one normalized characteristic that is shared between two or more cloud infrastructure topologies.

9. The non-transitory computer readable medium of claim 8, wherein the cloud parameters comprise a physical topology characteristic or a physical infrastructure characteristic.

10. The non-transitory computer readable medium of claim 8, wherein the cloud parameters comprise a logical topology characteristic or a logical infrastructure characteristic.

11. The non-transitory computer readable medium of claim 8, wherein a logical topology characteristic or a logical infrastructure characteristic characterizes at least one of, a virtual machine within the two or more cloud infrastructure topologies, or a virtual disk within the two or more cloud infrastructure topologies.

12. The non-transitory computer readable medium of claim 8, wherein the cloud parameters are synchronized between the first cloud infrastructure and the second cloud infrastructure using tenant-scoped synchronization wherein topology information is shared between the first cloud infrastructure and the second cloud infrastructure.

13. The non-transitory computer readable medium of claim 8 wherein the one or more cloud parameters describe characteristics up to, but not inside, boundaries of respective tenant partitions.

14. The non-transitory computer readable medium of claim 1, wherein one or more cloud parameters are synchronized between at least two of, a first public cloud, a second public cloud, or on-premises infrastructure.

15. A method for managing a virtualized application deployment, the method comprising:
deploying at least two tenant partitions, wherein a first one of the at least two tenant partitions is hosted on a first cloud infrastructure and wherein a second one of the at least two tenant partitions is hosted on a second cloud infrastructure;
accessing a first credentialing facility wherein an administrator is credentialed to provide access to a first set of one or more virtualization system entities on the first cloud infrastructure that hosts at least a first one of the at least two tenant partitions;
accessing a second credentialing facility wherein the administrator is credentialed to provide access to a second set of one or more virtualization system entities on the second cloud infrastructure, wherein the second set of one or more virtualization system entities has at least one difference from the first set of one or more virtualization system entities; and
a user interface wherein at least some aspects of the first set of one or more virtualization system entities on first cloud infrastructure are presented in a first portion of the user interface and wherein at least some aspects of the second set of one or more virtualization system entities on second cloud infrastructure are presented in a second portion of the user interface.

16. The method of claim 15, wherein the user interface provides visibility to infrastructure resource demands or licensing demands made by processes that are situated within at least one of a plurality of hierarchically-organized tenant partitions.

17. The method of claim 16, further comprising, emitting one or more infrastructure usage reports, or one or more license usage report that correspond to at least one of the plurality of hierarchically-organized tenant partitions.

18. The method of claim 16, wherein at least some of the at least two tenant partitions correspond to at least one of, different departments, different organizational functions, or different organizational activities.

19. A system for managing a virtualized application deployment, the system comprising:
a storage medium having stored thereon a sequence of instructions; and
a processor that executes the sequence of instructions to cause the processor to perform acts comprising,
deploying at least two tenant partitions, wherein a first one of the at least two tenant partitions is hosted on a first cloud infrastructure and wherein a second one of the at least two tenant partitions is hosted on a second cloud infrastructure;
accessing a first credentialing facility wherein an administrator is credentialed to provide access to a first set of one or more virtualization system entities on the first cloud infrastructure that hosts at least a first one of the at least two tenant partitions;
accessing a second credentialing facility wherein the administrator is credentialed to provide access to a second set of one or more virtualization system entities on the second cloud infrastructure, wherein the second set of one or more virtualization system entities has at least one difference from the first set of one or more virtualization system entities; and
a user interface wherein at least some aspects of the first set of one or more virtualization system entities on first cloud infrastructure are presented in a first portion of the user interface and wherein at least some aspects of the second set of one or more virtualization system entities on second cloud infrastructure are presented in a second portion of the user interface.

20. The system of claim 19, wherein at least some of the at least two tenant partitions correspond to at least one of, different departments, different organizational functions, or different organizational activities.

21. The system of claim 19, wherein one or more cloud parameters are synchronized between at least two of, a first public cloud, a second public cloud, or on-premises infrastructure.

22. The system of claim 19, wherein one or more cloud parameters describe at least one normalized characteristic that is shared between two or more cloud infrastructures.

23. The system of claim 22, wherein the cloud parameters comprise at least one of, a physical topology characteristic or a physical infrastructure characteristic, or a logical topology characteristic or a logical infrastructure characteristic.

24. The system of claim 19, wherein the user interface provides visibility to infrastructure resource demands or licensing demands made by processes that are situated within at least one of a plurality of hierarchically-organized tenant partitions.
